(19) United States
(12) Patent Application Publication
(10) Pub. No.: US 2026/0099022 A1
(43) Pub. Date: Apr. 9, 2026

(54) OPTICAL COMMUNICATION INTERCONNECT DEVICE AND MANUFACTURING METHOD THEREOF

(71) Applicant: CHIH-HSIAO CHEN, NEW TAIPEI CITY (TW)

(72) Inventor: CHIH-HSIAO CHEN, NEW TAIPEI CITY (TW)

(21) Appl. No.: 19/351,330

(22) Filed: Oct. 7, 2025

(30) Foreign Application Priority Data
Oct. 9, 2024 (TW) 113138519

(51) Int. Cl. G02B 6/43; G02B 6/42; H04B 10/80

(52) U.S. Cl. CPC G02B 6/43; H04B 10/801; G02B 6/4214

(57) ABSTRACT

An optical communication interconnect device and a manufacturing method thereof are provided. Along the X-axis in a 3-dimensional (XYZ) space, a waveguide array unit having at least one waveguide member, an active optical component array unit with at least one active optical component, and a mother substrate unit with at least one subsidiary substrate are aligned, positioned, and connected. Gaps between the units are filled fully by a filler whose optical index is larger than that of air. The waveguide member, the active optical component, and the subsidiary substrate are connected by one-on-one coupling of optical axes or position reference axes along the X-axis to form an optical channel without air or vacuum gaps. Thereby the optical communication interconnect device is formed by optical channels spaced apart at a YZ plane to form an array. High coupling efficiency and transmission density are achieved.

### CROSS-REFERENCE TO RELATED APPLICATIONS

This non-provisional application claims priority under 35 U.S.C. § 119(a) on Patent Application No(s). 113138519 filed in Taiwan, R.O.C. on Oct. 9, 2024, the entire contents of which are hereby incorporated by reference.

### BACKGROUND OF THE INVENTION

The present invention relates to an optical interconnect device, especially to an optical communication interconnect device applied to an optical communication field and a manufacturing method thereof.

A conventional optical communication waveguide includes several components connected at a light source end and a receiving end. At the light source end, light emitted from the light source is passed through a focusing mirror and air and then entering a waveguide in turn. At the receiving end, the light is passed the waveguide and air and entering an optical receiver. That means there is at least one air medium layer between an active optical component and the waveguide. Such conventional connection way of the active optical component with the waveguide makes a longer distance form between the active optical component and the waveguide and at least one air medium layer exist between the active optical component and the waveguide. The above connection has negative effects on not only optical coupling efficiency between the active optical component and the waveguide, but also construction of array-type optical interconnect with high space density. Moreover, prior arts related to the present invention include IEEE PHOTONICS TECHNOLOGY LETTERS, VOL. 9, NO. 2, February 1997, page 253, “A Two-Dimensional Optical Parallel Transmission Using a Vertical-Cavity Surface-Emitting Laser Arreay Module and Image Fiber” and IEEE Photonics Journal Volume 1, Number 1, June 2009, “Pixel-to-Pixel Fiber-coupled Emissive Micro-Light-Emitting Diode Arrays”. However, technical features of the present invention are not provided by the above prior arts. The present device provides an optical communication interconnect device with stable structure, no noise from adjacent optical channels, high space density, and large-quantity array-type optical interconnect.

### SUMMARY OF THE INVENTION

Therefore, it is a primary object of the present invention to provide an optical communication interconnect device and a manufacturing method thereof. Along the X-axis in a 3-dimensional (XYZ) space, a waveguide array unit having at least one waveguide member, an active optical component array unit provided with at least one active optical component, and a mother substrate unit provided with at least one subsidiary substrate are aligned with and positioned relative to one another in turn, and connected and fixed into one part. Gaps between the respective units are filled fully by a filler whose optical index is larger than an optical index of air. The waveguide member, the active optical component, and the subsidiary substrate are connected in turn along the X-axis by one-on-one coupling of respective optical axes or corresponding position reference axes to form an optical channel without any air or vacuum gaps. Thereby the optical communication interconnect device includes the at least one optical channel. The optical channels are spaced apart at a YZ plane in the 3-dimensional (XYZ) space to form an array. The purposes of high coupling efficiency and high transmission density are also achieved.

In order to achieve the above objects, an optical communication interconnect device and a manufacturing method thereof according to the present invention includes a waveguide array unit, an active optical component array unit, and a mother substrate unit in turn along the X-axis in 3-dimensional (3D) space. The above units are aligned with and positioned relative to one another and connected to form one part. The waveguide array unit includes at least one waveguide member. The waveguide members are spaced apart and arranged at the YZ plane in a 3D (XYZ) space to form an array. An optical axis of the waveguide member is parallel to the X-axis. A plane on a surface of one side of the waveguide member facing the active optical component array unit, located closest to the active optical component array unit, and perpendicular to the X-axis is defined as a first YZ plane. That means the first YZ plane is perpendicular to the X-axis and the optical axes of the respective waveguide members. The active optical component array unit includes at least one active optical component. The active optical components are spaced apart and arranged at the YZ plane in the 3D (XYZ) space to form an array. An optical axis of the active optical component is parallel to the X-axis. A plane on a surface of one side of the active optical component array unit facing the waveguide array unit, located closest to the waveguide array unit, and perpendicular to the X-axis is defined as a second YZ plane. That means the second YZ plane is perpendicular to the X-axis and the optical axis of each of the active optical components. The mother substrate unit includes at least one subsidiary substrate. The subsidiary substrates are spaced apart and arranged at the YZ plane in the 3D (XYZ) space to form an array. Each of the subsidiary substrates is provided with a corresponding position reference axis parallel to the X-axis. Along the X-axis, the subsidiary substrate includes a first surface and a second surface. The first surface is facing and close or connected to the active optical components of the active optical component array unit while the second surface is located opposite to the first surface along the X-axis. The first YZ plane is parallel and attached closely to the second YZ plane and a gap between the first YZ plane and the second YZ plane is filled completely by a filler. An optical index (refractive index) of the filler is larger than an optical index of air so that there is no air gap or vacuum gap between the waveguide array unit and the active optical component array unit. The optical axis of each of the waveguide members in the waveguide array unit is coupled to both the optical axis of each of the active optical components in the active optical component array unit and the position reference axis of each of the subsidiary substrates in the mother substrate unit in a one-on-one manner. Thereby the waveguide members, the active optical components, and the subsidiary substrates are connected in turn along the X-axis to form an optical channel without any air gap or vacuum gap correspondingly. Therefore, the optical communication interconnect device includes the at least one optical channel and the respective optical channels are spaced apart and arranged at the YZ plane in the 3D (XYZ) space to form an array.

Preferably, the optical index of the filler is between an optical index of a core of the waveguide member and an optical index of a photoelectric conversion material of the active optical component so as to reduce reflectivity of material interfaces between the core of the waveguide member and the photoelectric conversion material of the active optical component.

Preferably, a focusing mirror is disposed on the second surface of the subsidiary substrate of the mother substrate unit. The focusing mirror includes but not limited to, concave mirror, Fresnel mirror, and Grating mirror. An optical axis of the focusing mirror is coupled to the position reference axis of the subsidiary substrate, the optical axis of the active optical component, and the optical axis of the waveguide member.

Preferably, when the active optical component of the active optical component array is a light emitting diode (LED) or vertical cavity surface emitting laser (VCSEL), the optical communication interconnect device includes the at least one optical channel. The optical channels which are spaced apart and arranged at the YZ plane in the 3D (XYZ) space to form a two-dimensional array.

Preferably, when the active optical component of the active optical component array is an edge emitting laser, the optical communication interconnect device includes the at least one optical channel. The optical channels are spaced apart and arranged at the YZ plane in the 3D (XYZ) space to form a 1-diemsnional array.

Preferably, the waveguide member of the waveguide array unit includes common optical fiber, a waveguide, and a gradient index (GRIN) waveguide (GRIN lens).

In order to achieve the above objects, a manufacturing method of an optical communication interconnect device according to the present invention includes the following steps. Step S1: producing a waveguide array unit which includes at least one waveguide member. The waveguide members are spaced apart and arranged at the YZ plane in a 3D (XYZ) space to form an array. An optical axis of the waveguide member is parallel to the X-axis in the 3D (XYZ) space. A first YZ plane is formed or defined by a plane on a surface of one side of the waveguide array unit facing an active optical component array unit, closest to the active optical component array unit, and perpendicular to the X-axis. Step S2: producing an active optical component array unit which includes at least one active optical component. The active optical components are spaced apart and arranged at the YZ plane in the 3D (XYZ) space to form an array. An optical axis of the active optical component is parallel to the X-axis. A second YZ plane is defined by a plane on a surface at one side of the active optical component facing the waveguide array unit, closest to the waveguide array unit, and perpendicular to the X-axis. Step S3: producing a mother substrate unit which includes at least one subsidiary substrate. The subsidiary substrates are spaced apart and arranged at the YZ plane in the 3D (XYZ) space to form an array. Along the X-axis, the subsidiary substrate is provided with a first surface and a second surface. The first surface of the subsidiary substrate is facing the active optical components of the active optical component array unit while the second surface is located opposite to the first surface along the X-axis. Step S4: performing alignment and positioning of the waveguide array unit, the active optical component array unit, and the mother substrate unit, and connecting and fixing the waveguide array unit, the active optical component array unit, and the mother substrate unit into one part along the X-axis in the 3D (XYZ) space. The first YZ plane is parallel and attached closely to the second YZ plane. All gaps between the waveguide array unit and the active optical component array unit are filled completely by a filler. An optical index of the filler is larger than an optical index of air. Thereby there is no air gap or vacuum gap between the waveguide array unit and the active optical component array unit. The optical axis of each of the waveguide members of the waveguide array unit is coupled to the optical axis of each of the active optical components of the active optical component array unit in a one-on-one manner so that the waveguide members, the active optical components, and the subsidiary substrates are connected in turn along the X-axis to form an optical channel without any air gap or vacuum gap correspondingly. Step S5: finishing assembly of the optical communication interconnect device which includes the at least one optical channel and the optical channels are spaced apart and arranged at the YZ plane of the 3D (XYZ) space to form an array.

### BRIEF DESCRIPTION OF THE DRAWINGS

FIG. 1 is a sectional view of a XY plane of an embodiment of an optical communication interconnect device (in which an active optical component is LED or VCESL) according to the present invention;

FIG. 2 is a sectional view of the embodiment in FIG. 1 showing light emitted according to the present invention;

FIG. 3 is a sectional view along line 3-3 of the embodiment in FIG. 2 according to the present invention;

FIG. 4 is a sectional view along line 4-4 of the embodiment in FIG. 2 according to the present invention;

FIG. 5A is a sectional view along line 5A-5A of the embodiment in FIG. 2 according to the present invention;

FIG. 5B is a sectional view along line 5B-5B of the embodiment in FIG. 2 according to the present invention;

FIG. 6A is a sectional view showing a structure of a manufacturing process (Step S3-1) of manufacturing a mother substrate unit (Step S3) according to the present invention;

FIG. 6B is a sectional view showing a structure of the next process (Step S3-2) of the embodiment in FIG. 6A according to the present invention;

FIG. 6C is a sectional view showing a structure of the next process (Step S3-3) of the embodiment in FIG. 6B according to the present invention;

FIG. 6D is a sectional view showing a structure of the next process (Step S3-4) of the embodiment in FIG. 6C according to the present invention;

FIG. 6E is a sectional view showing a structure of the next process (Step S3-5) of the embodiment in FIG. 6D according to the present invention;

FIG. 7A is a sectional view showing a structure of the next process (Step S3-6) of the embodiment in FIG. 6E according to the present invention;

FIG. 7B is a sectional view showing a structure of the next process (Step S3-7) of the embodiment in FIG. 7A according to the present invention;

FIG. 7C is a sectional view showing a structure of the next process (Step S3-8) of the embodiment in FIG. 7B according to the present invention;

FIG. 7D is a sectional view showing a structure of the next process (Step S3-9) of the embodiment in FIG. 7C according to the present invention;

FIG. 8 is a sectional view showing a structure of manufacturing an active optical component array unit (LED, VCESL, optical detector) on an epitaxial substrate (Step S2) of an embodiment according to the present invention;

FIG. 9A is a sectional view showing a structure of connecting the mother substrate unit and the active optical component array unit (active optical components on the epitaxial substrate) to form a combination body of an embodiment according to the present invention;

FIG. 9B is a sectional view showing a structure of the next process (removal of the epitaxial substrate) of the embodiment in FIG. 9A according to the present invention;

FIG. 9C is an assembled view along the XY plane showing connection of a waveguide array unit with the combination body (the mother substrate unit connected with the active optical component array unit into one part) shown in FIG. 9B of an embodiment according to the present invention;

FIG. 10 is a sectional view of the waveguide array unit along the XY plane of an embodiment according to the present invention;

FIG. 11 is a sectional view of a XZ plane of a mother substrate unit in another embodiment in which an active optical component is an edge emitting light source of an optical communication interconnect device according to the present invention;

FIG. 12 is a sectional view of a XZ plane of the mother substrate unit of the embodiment in FIG. 11 according to the present invention;

FIG. 13 is a sectional view of a YZ plane of another embodiment in which the active optical component is an edge emitting light source and an active optical component array unit is arranged at an epitaxial substrate according to the present invention;

FIG. 14 is a sectional view of a XZ plane of the embodiment in FIG. 11 in which the active optical component array unit is arranged at the epitaxial substrate according to the present invention;

FIG. 15 is a sectional view of a YZ plane showing the mother substrate unit in FIG. 11 combined with the active optical component array unit on the epitaxial substrate in FIG. 14 to form one part according to the present invention;

FIG. 16 is a schematic drawing a structure of the active optical component array unit of the embodiment in FIG. 15 after removal of the epitaxial substrate according to the present invention;

FIG. 17 is a XZ plane view of the embodiment in FIG. 15 according to the present invention;

FIG. 18 is a XZ plane view of the embodiment in FIG. 16 according to the present invention;

FIG. 19 is a XZ plane view showing a combination body of the mother substrate unit with the active optical component array unit (without the epitaxial substrate) and a waveguide array unit before being assembled with each other according to the present invention;

FIG. 20 is a XZ plane view of the embodiment in FIG. 19 after being assembled according to the present invention;

FIG. 21 is a schematic drawing showing light emitted at a XZ plane of the embodiment in FIG. 20 according to the present invention;

FIG. 22 is a XY plane view of the light emitted in the embodiment in FIG. 21 according to the present invention;

FIG. 23 is a partial enlarged schematic drawing at a XY plane of the active optical component (21) of the embodiment in FIG. 8 according to the present invention;

FIG. 24 is a XZ plane view of the active optical component (21) of the embodiment in FIG. 23 according to the present invention;

FIG. 25 is a sectional view (XZ plane) along a line 25-25 of the embodiment in FIG. 24 (photoelectric conversion materials) according to the present invention;

FIG. 26 is a partial enlarged schematic drawing at a XY plane of the active optical component (81) of the embodiment in FIG. 13 according to the present invention;

FIG. 27 is a XZ plane view of the active optical component (81) of the embodiment in FIG. 26 according to the present invention;

FIG. 28 is a sectional view (XZ plane) along a line 28-28 of the embodiment in FIG. 27 according to the present invention;

FIG. 29 is a XY plane view showing light emitted from an embodiment in which a width of a section of a photoelectric conversion material of a light source is smaller than a width of a section of a waveguide member according to the present invention;

FIG. 30A and FIG. 30B show a sectional view (XZ plane) along a line 30-30 of the embodiment in FIG. 20 according to the present invention;

FIG. 31A and FIG. 31B are respectively enlarged views of a surface (13) and a first YZ plane (14) of the embodiment in FIG. 30A and FIG. 30B according to the present invention;

FIG. 32 is a partial enlarged view of a XY plane of a waveguide array unit of an embodiment according to the present invention;

FIG. 33, FIG. 34, and FIG. 35 are respectively sectional views (XZ plane) along lines 33-33, 34-34, and 35-35 according to the present invention.

### DETAILED DESCRIPTION OF THE PREFFERED EMBODIMENT

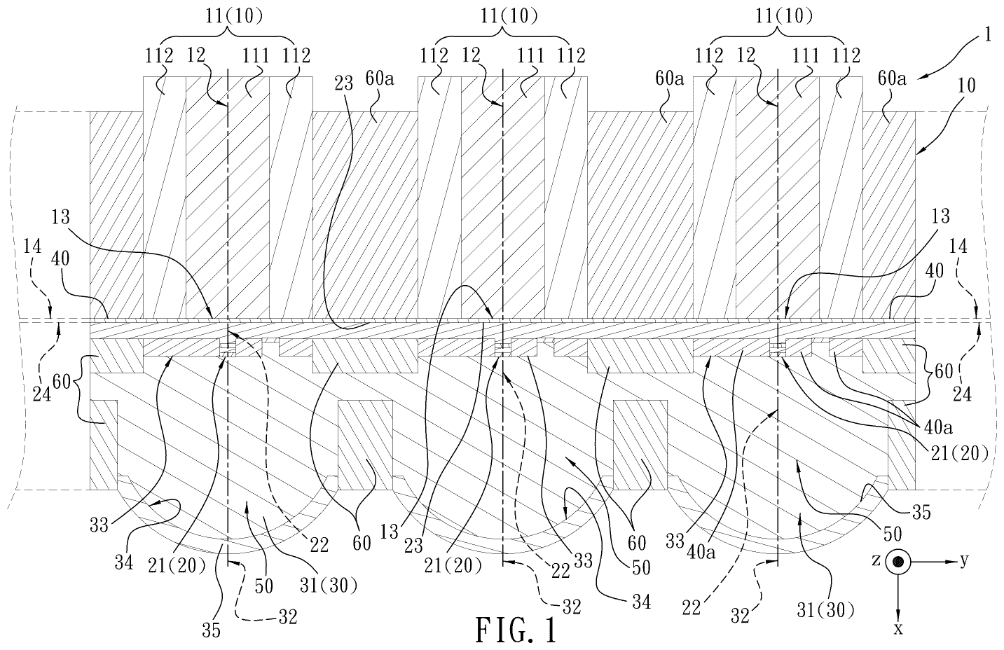

Refer to FIG. 1-5, an optical communication interconnect device 1 according to the present invention includes a waveguide array unit 10, an active optical component array unit 20, and a mother substrate unit 30 in turn along the X-axis in 3-dimensional (3D) space. The waveguide array unit 10, the active optical component array unit 20, and the mother substrate unit 30 are mutually aligned, positioned and connected to be fixed into one part.

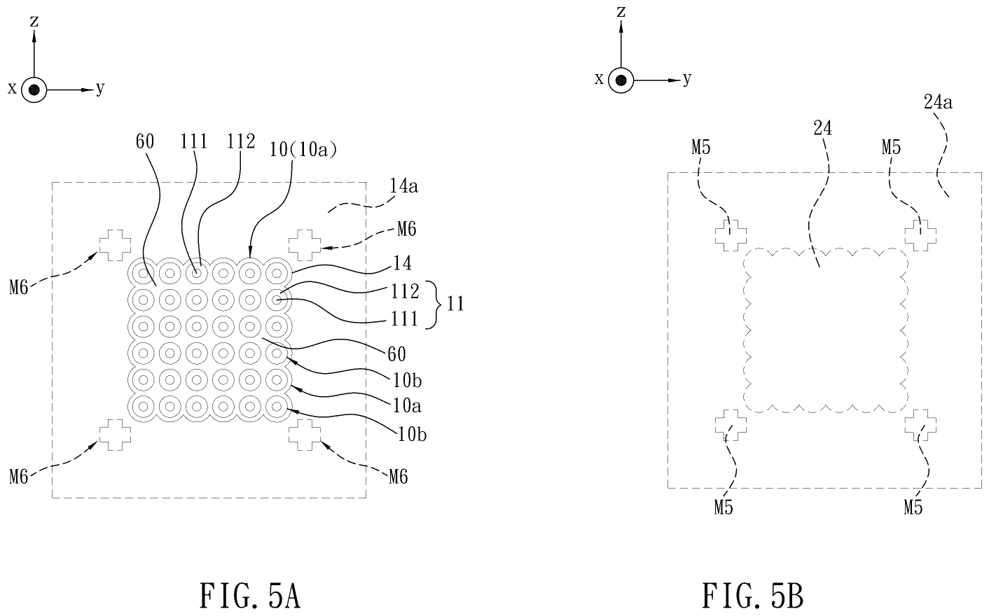

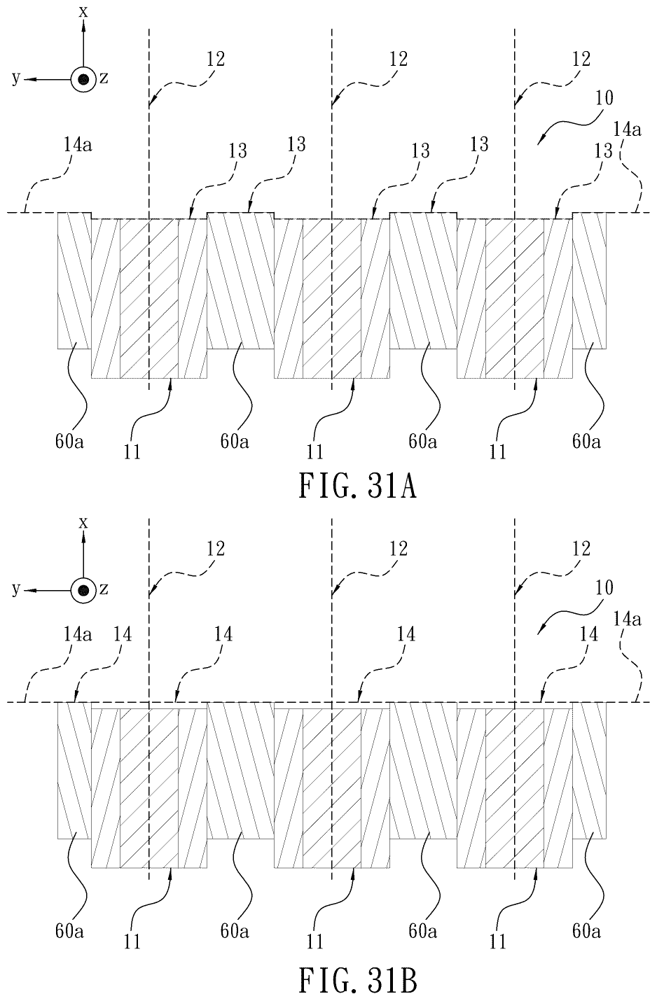

The waveguide array unit 10 includes at least one waveguide member 11. In a preferred embodiment, the waveguide members 11 are spaced apart to form an array at the YZ plane in the 3D (XYZ) space, as shown in FIG. 5. In this embodiment, the waveguide member 11 which is an optical fiber is taken as an example. Each of the waveguide members 11 consists of a waveguide core 111 and a waveguide cladding layer 112 disposed around the waveguide core 111. A light absorption body 60a made of light absorption materials (such as light absorption ceramic) is arranged between the waveguide members 11. An optical axis 12 of the waveguide member 11 is parallel to the X-axis. A surface 13 is formed at one side of each of the waveguide members 11 facing the active optical component array unit 20. More generally, the surface 13 may be corrugated (as shown in FIG. 31A and FIG. 31B). A plane at one side of the surface 13 closest to the active optical component array unit 20 and perpendicular to the X-axis is defined as a first YZ plane 14 (as shown in FIG. 31A and FIG. 31B). The first YZ plane 14 is perpendicular to the X-axis and the optical axis 12 of the waveguide member 11 which includes common optical fiber, a waveguide, and a gradient index waveguide (Grin lens). The following is a method of manufacturing the waveguide array unit 10, note intended to limit the present invention. First use light absorption materials such as light absorption ceramic or polymer such as polyimide to produce a carrier plate 10a, as shown in FIG. 5A. A plurality of holes 10b arranged according to a preset array is disposed on the carrier plate 10a. Then the waveguide members 11 are inserted and positioned in the holes 10b in a one-on-one manner.

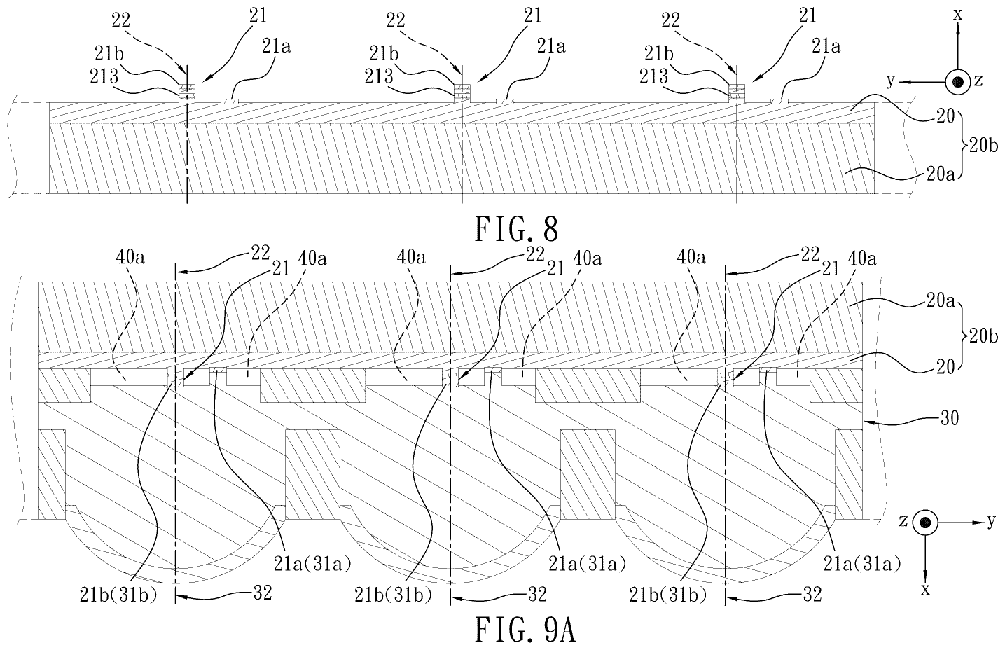

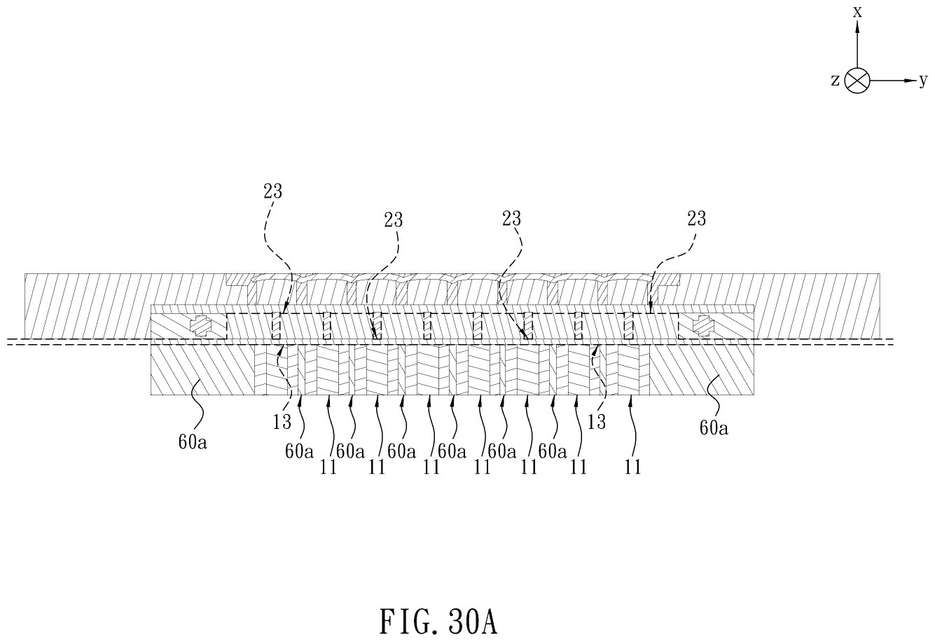

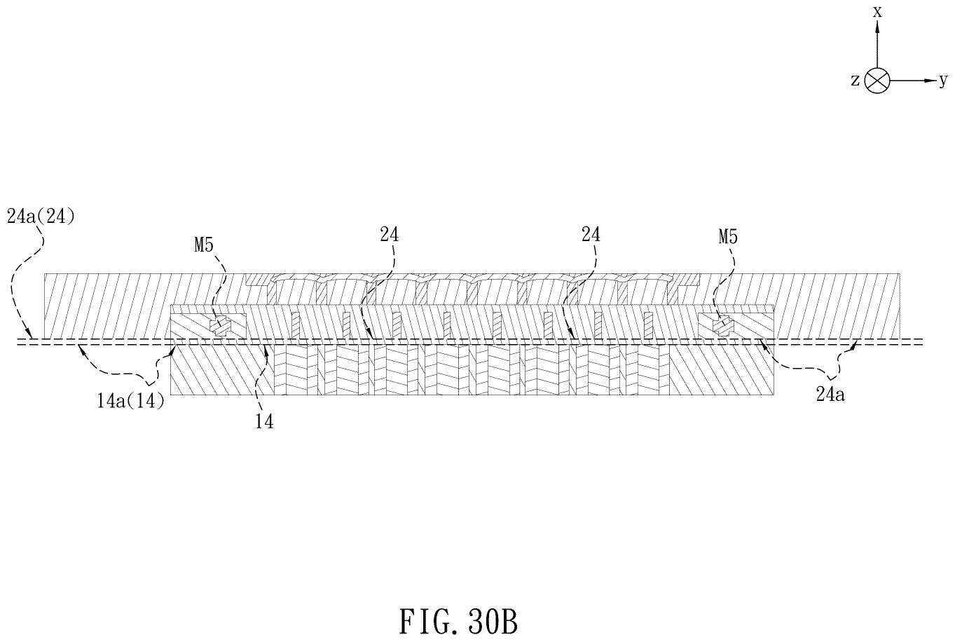

The active optical component array unit 20 includes at least one active optical component 21. In a preferred embodiment, the active optical components 21 are spaced apart and arranged at the YZ plane in the 3D (XYZ) space to form an array, as shown in FIG. 4. Each of the active optical components 21 includes a light emitting component (a light source which converts electrical energy into light energy such as light emitting diode (LED), laser) or an optoelectronic component (optical detector/photodetector that converts light into electricity). The light emitting component includes LED and vertical cavity surface emitting laser (VCSEL). In this embodiment, the active optical components 21 is MicroLED and taken as an example, as shown in FIG. 1, FIG. 4, and FIG. 8. The active optical component array unit 20 can be considered as a MicroLED chip as shown in FIG. 1, FIG. 4, and FIG. 8. The active optical component 21 can be considered as various photoelectric conversion materials produced and formed on the MicroLED chip including photoelectric conversion or photon emitting materials such as materials with PN Junction. In the following embodiment, the active optical component 21 is a combination body of photoelectric conversion materials 213 with electric contact and solder surfaces 21a, 21b. An optical axis 22 of the active optical component 21 is parallel to the X-axis. A surface 23 a surface at one side of the active optical component 21 facing the waveguide array unit 10. Generally speaking, the surface 23 may be corrugated (as shown in FIG. 30A). A plane at one side closest to the waveguide array unit 10 and perpendicular to the X-axis is defined as a second YZ plane 24 (as shown in FIG. 30B). The second YZ plane 24 is perpendicular to the X-axis and the optical axis 22 of each of the active optical components 21.

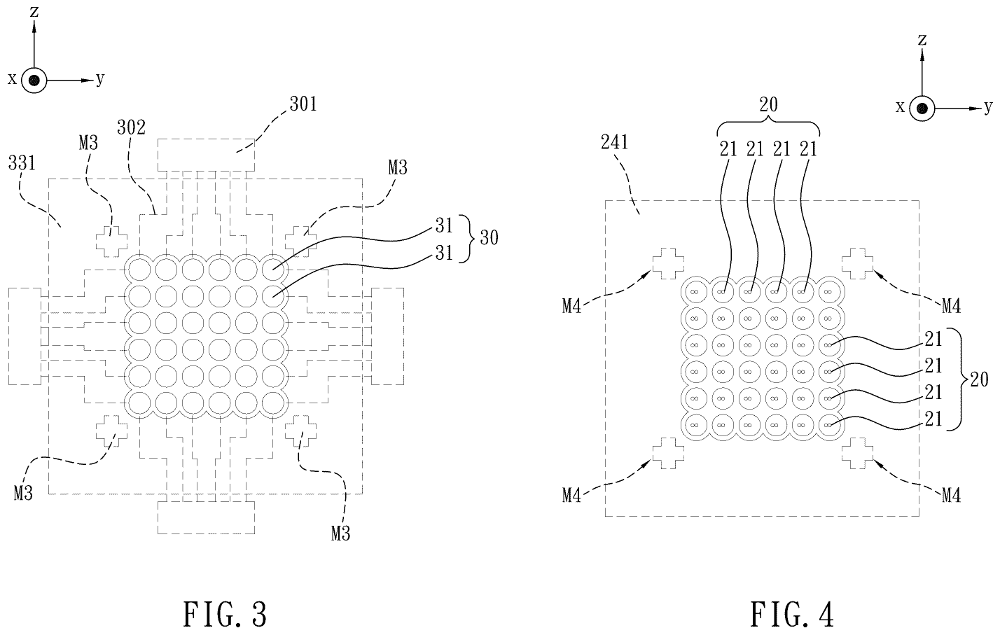

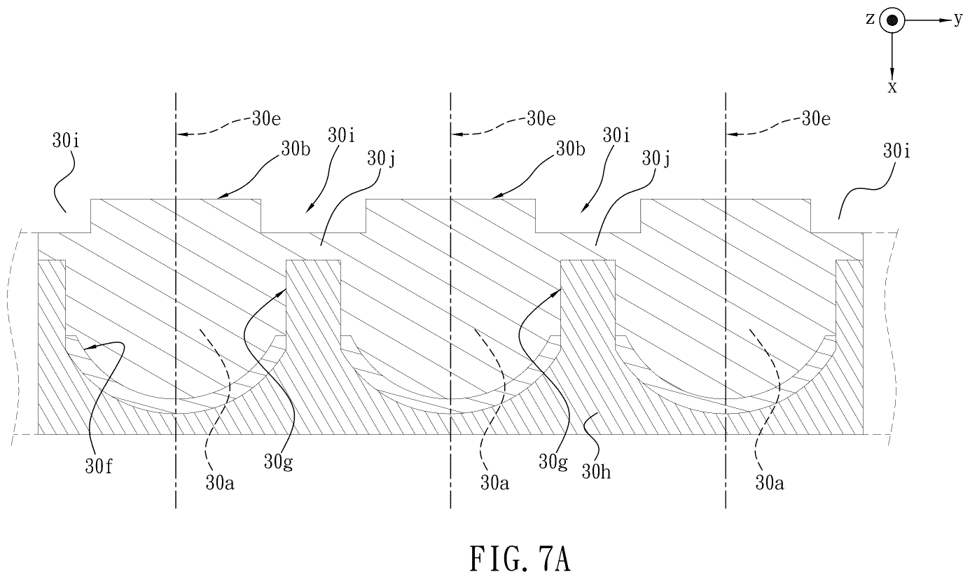

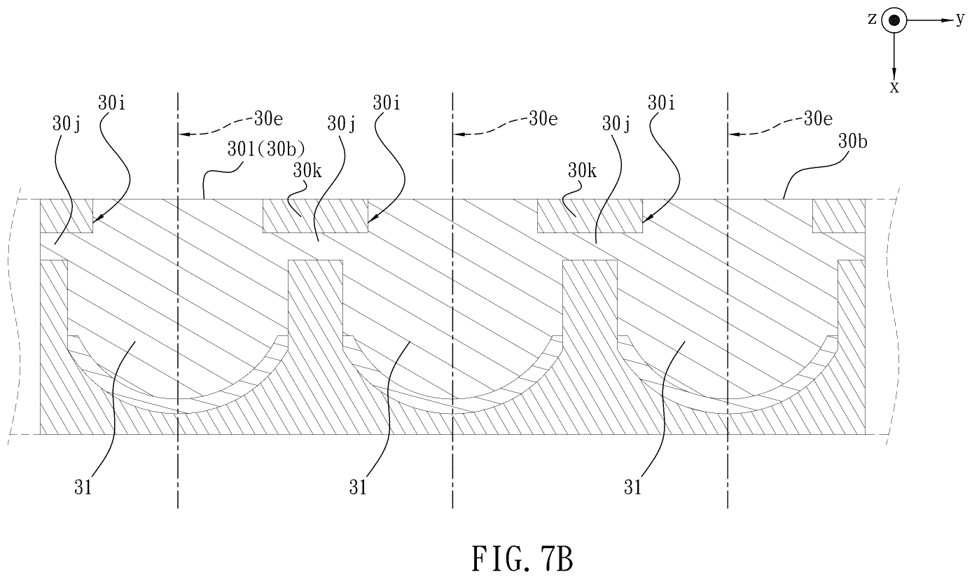

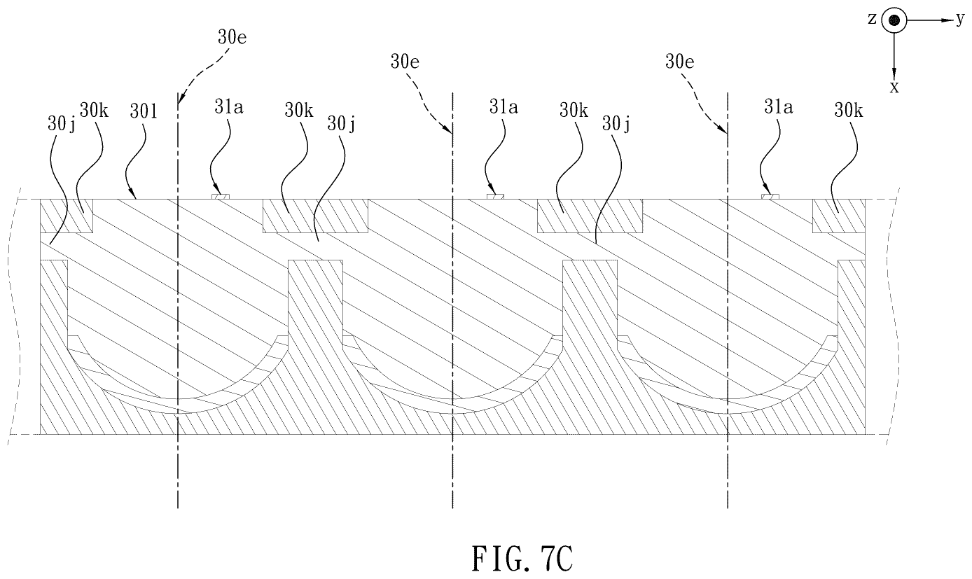

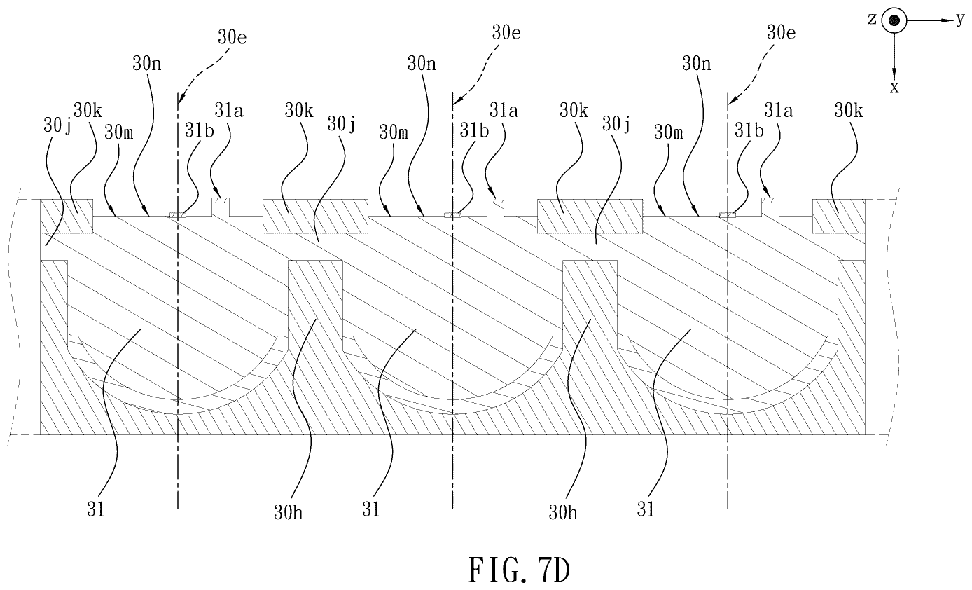

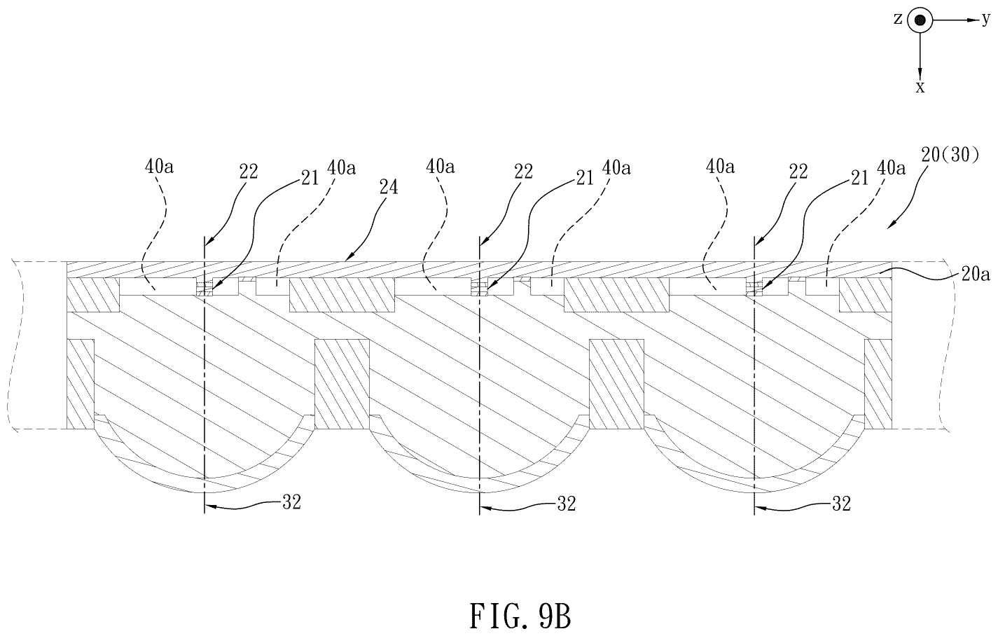

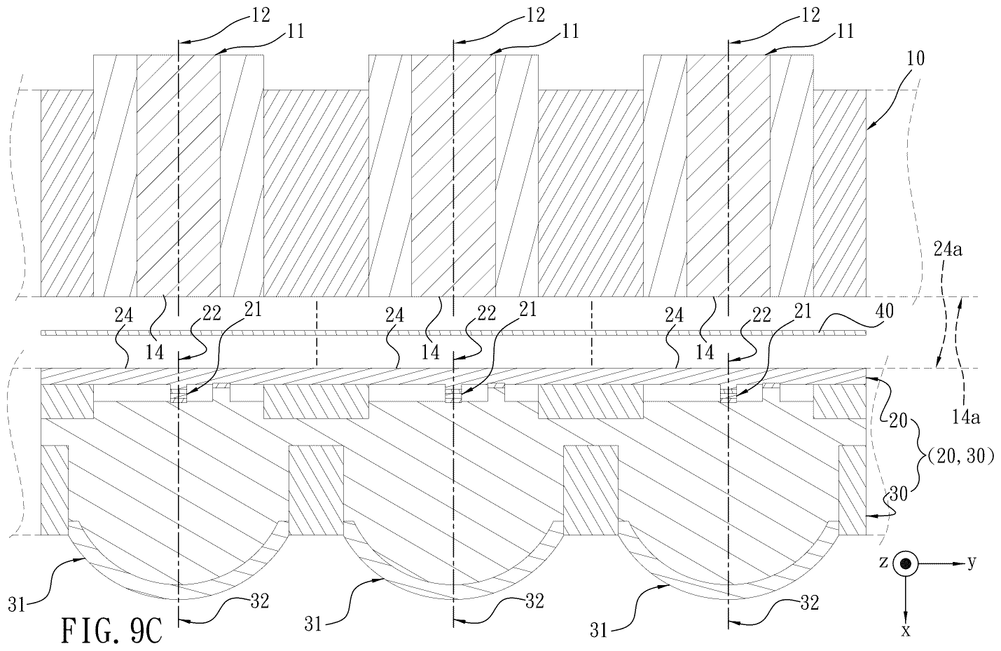

The mother substrate unit 30 is made of no light absorption materials including but not limited to semiconductors, glass, acrylic, and transparent ceramics. The mother substrate unit 30 includes at least one subsidiary substrate 31. In a preferred embodiment, the subsidiary substrates 31 are spaced apart and arranged at the YZ plane in the 3D (XYZ) space to form an array, as shown in FIG. 3. According to the optical axis 22 of the active optical component 21, each of the subsidiary substrates 31 can be preset with a corresponding position reference axis 32 parallel to the X-axis. Along the X-axis, the subsidiary substrate 31 is provided with a first surface 33 and a second surface 34. The first surface 33 of the subsidiary substrate 31 is facing and close or connected to the active optical components 21 of the active optical component array unit 20 while the second surface 34 is located opposite to the first surface 33 along the X-axis. Refer to FIG. 7D, FIG. 8, and FIG. 9A, an electric contact and solder surface 31a disposed on the subsidiary substrate 31 is arranged at a position of the YZ plane and the position is aligned with the position of the electric contact and solder surface 21a of the active optical component 21 on the YZ plane. A position of an electric contact and solder surface 31b disposed on the subsidiary substrate 31 at the YZ plane is aligned with the position of the electric contact and solder surface 21b of the active optical component 21 on the YZ plane. Thereby when the active optical component 21 is placed and mounted to the subsidiary substrate 31, the electric contact and solder surfaces 21a, 21b are electrically connected to the electric contact and solder surfaces 31a, 31b correspondingly.

Refer to FIG. 1 and FIG. 9C, the first YZ plane 14 is parallel and attached closely to the second YZ plane 24 and a gap between the first YZ plane 14 and the second YZ plane 24 is filled completely by a filler 40. An optical index of the filler 40 is larger than an optical index of air and the filler 40 doesn't absorb optical signals of respective optical channels 50. Thus there is no air gap or vacuum gap between the waveguide array unit 10 and the active optical component array unit 20. The optical axis 12 of each of the waveguide members 11 is coupled to both the optical axis 22 of each of the active optical components 21 and the position reference axis 32 of each of the subsidiary substrates 31 in a one-on-one manner. Thereby the waveguide members 11, the active optical components 21, and the subsidiary substrates 31 are connected in turn along the X-axis to form the optical channel 50 without any air gap or vacuum gap correspondingly. Therefore, the optical communication interconnect device 1 includes the at least one optical channel 50. The respective optical channels 50 are spaced apart and arranged at the YZ plane in the 3D (XYZ) space to form an array. This is the main technical feature of the present optical communication interconnect device 1.

The active optical component 21 is a semiconductor light source which emits light toward the waveguide member 11. The closer the active optical component 21 to the waveguide member 11, the larger a solid angle of the light emitted from the light source toward the waveguide member 11. Then the light is entering and propagating in the waveguide member 11. That means optical coupling efficiency between the light source and the waveguide is higher. Similarly, if the active optical component 21 is an optical detector and getting closer to the waveguide member 11, the light of the waveguide member 11 has a larger solid angle, being absorbed by a part of the optical detector facing the waveguide. That means optical coupling efficiency between the waveguide and the optical detector is higher. Thus a distance between the first YZ plane 14 and the second YZ plane 24 in the X axis should be as smaller as possible. In theory, the optimal way is that there is no distance between the first YZ plane 14 and the second YZ plane 24, both attached completely. In fact, the first YZ plane 14 and the second YZ plane 24 are impossible to be in parallel completely and there must be a gap between them. The refractive index (optical index) of the waveguide member 11 and the active optical component 21 are far more than the refractive index of air or vacuum. Once there is air or vacuum in the gap, transmission of the light between the waveguide member 11 and the active optical component 21 will have larger changes in the reflective index. And the light has larger reflection and refraction on the first YZ plane 14 and the second YZ plane 24. Thereby the optical coupling efficiency between the active optical component 21 and the waveguide member 11 is reduced. The filler 40 used in the present invention is selected from materials with the optical index larger than the optical index of the air or vacuum and this really improves the optical coupling efficiency between the active optical component 21 and the waveguide member 11.

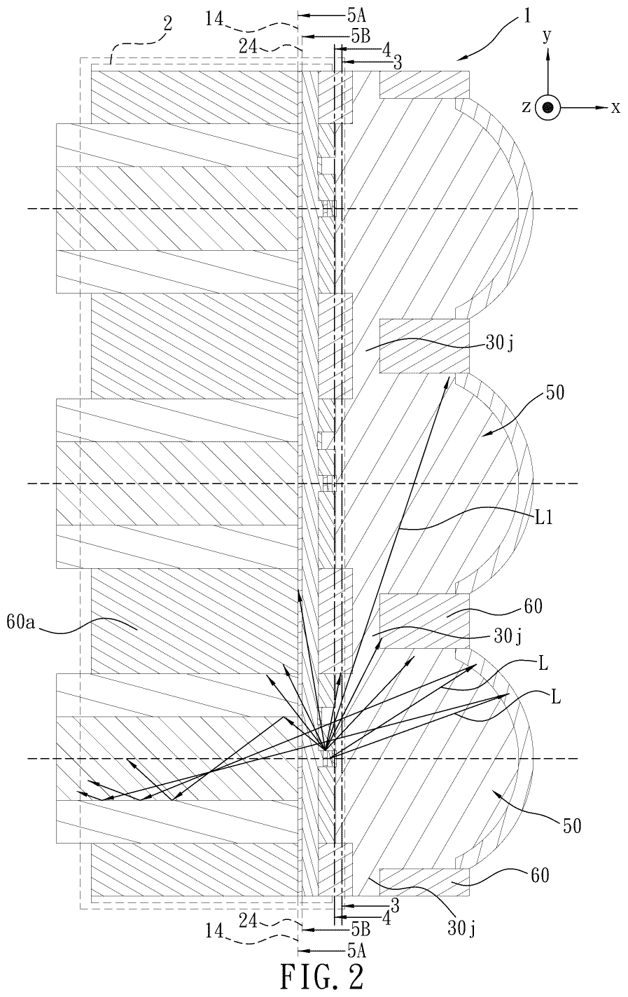

The filler 40 is in a gel or liquid form. When the filler 40 is a gel filler, the filler 40 is also used as an adhesive. Thereby the waveguide array unit 10 and the active optical component array unit 20 are positioned and connected relative to each other integrally after curing of the gel filler 40. Moreover, the gel filler 40 can be cured over time, or by light or heating. After curing, peripheries of the active optical component array unit 20 and the active optical component 21 are covered by the gel filler 40 so that package structural strength of the optical communication interconnect device 1 is enhanced. When the filler 40 is a liquid filler, as shown in FIG. 2, a housing 2 is disposed around and tightly covering the gap between the waveguide array unit 10 and the active optical component array unit 20. Thus the liquid filler 40 is freely flowing in a space inside the housing 2 including all of the gaps between the waveguide array unit 10 and the active optical component array unit 20 for providing heat dissipation effect to the active optical component array unit 20.

The alignment, positioning, and coupling of the optical axis 22 of the active optical component array unit 20 with the optical axis 12 of the waveguide array unit 10 can use the following “optical axis alignment feedback mechanism”. An optical axis alignment mechanism generally includes a five-dimensional adjustment with variables of x, y, z, Ø_{y}, Ø_{z}. When the first YZ plane 14 and the second YZ plane 24 are getting closer, positions of a normal line of the first YZ plane 14 and a normal line of the second YZ plane 24 skew to each other are detected. The detection of the positions includes the following examples, but not limited. Example 1: detect and compare a plurality of positions of the gaps at (Y, Z) plane in the X axis of the first YZ plane 14 and the second YZ plane 24. Example 2: detect pressure of a plurality of positions at (Y, Z) plane when the first YZ plane 14 and the second YZ plane 24 are in contact with each other. The above skew information is used as feedback to Ø_{y} and Ø_{z} of the optical axis alignment mechanism. Thus the first YZ plane 14 and the second YZ plane 24 are more parallel to each other. The more the first YZ plane 14 and the second YZ plane 24 parallel to each other, the higher the optical coupling efficiency between the optical axes 22 of the active optical component array unit 20 and the optical axes 12 of the waveguide array unit 10. When the first YZ plane 14 and the second YZ plane 24 have a larger continuous plane relatively (having the same YZ coordinates), there are fewer gaps between the first YZ plane 14 and the second YZ plane 24. Thus in practice, the optical axis alignment feedback mechanism can be used to make the normal line of the first YZ plane 14 and the normal line of the second YZ plane 24 become more parallel to each other. Thereby the optical coupling efficiency between the active optical component array unit 20 and the waveguide array unit 10 is increased.

In order to make the first YZ plane 14 and the second YZ plane 24 have a larger continuous plane relatively, the following ways can be used, but not limited. Firstly, when the active optical component 21 is a surface emitting light source (such as VCSEL, LED) or an optical detector, the normal line of the first YZ plane 14 is the optical axis 22 of emitted light or received light. The active optical component array unit 20 and an epitaxial substrate 20a are connected by flip chip, as shown in FIG. 8. Or as shown in Step S2-1 and Step S2-2 of a manufacturing method, the whole surface 23 forms the continuous second YZ plane 24. Secondly, when the active optical component 21 is an edge emitting light source (such as Fabry-Pérot (FP) laser, distributed-feedback laser (DFB) laser), depressions on the surface can be filled with materials having the optical index larger than the optical index of the air or vacuum so that a continuous plane with a larger area and belonging to the second YZ plane 24 is formed on a surface of the active optical component array unit 20. Thirdly, even the surface 23 (as shown in FIG. 30A which will be described later) has depressions at the area of the active optical component array unit 20, an extension plane 24a is formed on the surface 23 outside the area of a chip of the active optical component array unit 20 and continuous with the second YX plane 24 (as shown in FIG. 30B which will be described later).

The filler 40 can be in a gel or liquid form for filling all the gaps or depressions between the surface 13 and the surface 23 fully.

The active optical component array unit 20 and the mother substrate unit 30 are connected and electrical signals and energy between them are transmitted by the electric contact and solder surfaces 21a, 21b and the electric contact and solder surfaces 31a, 31b which are aligned and communicating with each other correspondingly (as shown in FIG. 7D, FIG. 8, FIG. 9A and FIG. 9B). Thus an electronic circuit 301 and conductive wire 302 can be constructed on the mother substrate unit 30. Or an integrated circuit (IC) is packaged on the mother substrate unit 30.

A focusing mirror 35 is disposed on the second surface 34 of the subsidiary substrate 31 and an optical axis 32 of the focusing mirror 35 (that's the preset position reference axis 32 of the subsidiary substrate 31) is parallel to the X-axis at one side close to the active optical component array unit 20. When the active optical component 21 is a semiconductor light source, light emitted from the active optical component 21 toward the focusing mirror 35 of the corresponding subsidiary substrate 31 can be entering the waveguide member 11 after being reflected and focused by the focusing mirror 35. When the active optical component 21 is a semiconductor photo detector (PD), light outputted from the waveguide member 11 toward the focusing mirror 35 of the corresponding subsidiary substrate 31 is entering the active optical component 21 after being reflected and focused by the focusing mirror 35. In practice of manufacturing the focusing mirror 35, the second surface 34 of the subsidiary substrate 31 is firstly produced into a curved surface with a focal point of reflected light located at one point close to the optical axis 22 of the active optical component 21. Then reflective materials are coated over the curved surface to form the focusing mirror 35.

The materials for the active optical component array unit 20 loaded with the active optical component 21 and materials for the subsidiary substrate 31 both have very little absorption of the optical signals of the respective optical channel 50. The materials include, but not limited to, semiconductors, ceramic, glass, and acrylic. The active optical component 21 is provided with the electric contact and solder surfaces 21a, 21b for conducting electrical signals of the corresponding subsidiary substrate 31, as shown in FIG. 8 and FIG. 9A. The subsidiary substrate 31 is provided with the electric contact and solder surfaces 31a, 31b for conducting electrical signals of the corresponding active optical component 21, as shown in FIG. 7D and FIG. 9A. The mother substrate unit 30 is also provided with the conductive wire 302 for connecting the electronic circuit 301 and the electric contact and solder surfaces 31a, 31b, as shown in FIG. 3. The materials for the electric contact and solder surfaces 21a, 21b, 31a, 31b or the conductive wire 302 have very little absorption of the optical signals of the respective optical channel 50. The materials include, but not limited to, indium tin oxide (ITO), conductive polymers, carbon nanotubes, graphene, ultra-thin metal, and nano metal meshes.

Refer to FIG. 1, FIG. 2, FIG. 8, and FIG. 9A, in practice of semicondutor manufacturing, positions of the electric contact and solder surface 21a of the active optical component 21 on the YZ plane are aligned with positions of the electric contact and solder surface 31a of the subsidiary substrate 31 on the YZ plane. Positions of the electric contact and solder surface 21b of the active optical component 21 on the YZ plane are aligned with positions of the electric contact and solder surface 31b of the subsidiary substrate 31 on the YZ plane. This helps the optical axis 22 of the light source of the active optical component 21 being precisely located at a corresponding position of the subsidiary substrate 31. That means the optical axis 22 of the light source of the active optical component 21 is coupled to the preset position reference axis 32 of the subsidiary substrates 31 in a one-on-one manner. Moreover, a light absorption body 60 made of light absorption materials is arranged between the two adjacent and connected active optical components 21 and the two adjacent and connected subsidiary substrates 31. The light absorption materials include, but not limited to, semiconductors, polyimide, and ceramic. The light absorption body 60 absorbs the light signals from the adjacent optical channels 50 so as to avoid interference noise (cross talk) between the adjacent optical channels 50 effectively. The light absorption body 60a made of light absorption materials (such as light absorption ceramic) is also arranged between the two connected and adjacent waveguide members 11. The light absorption materials include, but not limited to, semiconductors, polyimide, and ceramic. The light absorption body 60a can absorb the light signals from the adjacent optical channels 50 so as to avoid interference noise (cross talk) between the adjacent optical channels 50 effectively. Refer to FIG. 2, in light L emitted from the active optical component 21 of one of the two adjacent and connected optical channels 50, a part of lateral light L1 is passed through a gap 30j between the light absorption bodies 60a arranged between the optical channels 50 to be emitted to the adjacent optical channel 50. The gap 30j between the light absorption bodies 60 is a segment of communication body 30j belonging to a main body of the mother substrate body 30a between a first groove 30g corresponding to a second groove 30i in a one-on-one manner, as shown in FIG. 7A and FIG. 7B. The lateral light L1 passed through the communication body 30j is emitted to the light absorption bodies 60 of the adjacent and connected optical channels 50 to be absorbed. Thereby the interference noise (cross talk) generated between the adjacent and connected optical channels 50 can be avoided effectively. In other words, by geometric design of the light absorption bodies 60 extending in (Y, Z) direction (such as a width of the communication body 30j in Y-axis and a height of the communication body 30j in X-axis), the light emitted from respective light channels 50 to be entering the adjacent light channels 50 can be blocked.

Refer to FIG. 1-5, when the active optical component 21 of the active optical component array unit 20 is LED or VCSEL, the optical communication interconnect device 1 includes the at least one light channel 50 and the light channels 50 are spaced apart from one another on the YZ plane in the 3D (XYZ) space to form a two-dimensional array.

A method of manufacturing the optical communication interconnect device 1 includes the following steps.

Step S1: producing a waveguide array unit 10. Refer to FIG. 1 and FIG. 5A, the waveguide array unit 10 includes at least one waveguide member 11. The waveguide members 11 are spaced apart and arranged at the YZ plane in a 3D (XYZ) space to form an array. An optical axis 12 of the waveguide member 11 is parallel to the X-axis in the 3D (XYZ) space. A first YZ plane 14 is formed or defined by a surface at one side of the waveguide member 11 facing an active optical component array unit 20.

Step S2: producing an active optical component array unit 20. Refer to FIG. 1 and FIG. 4, the active optical component array unit 20 includes at least one active optical component 21. The active optical components 21 are spaced apart and arranged at the YZ plane in a 3D (XYZ) space to form an array. An optical axis 22 of the active optical component 21 is parallel to the X-axis. A second YZ plane 24 perpendicular to the X-axis is formed or defined by a surface of one side of the active optical component 21 facing the waveguide array unit 10. Refer to FIG. 8, the active optical component 21 includes a photoelectric conversion material 213 (PN junction), at least one electric contact and solder surface 21a in contact with a N-type layer of the photoelectric conversion material 213, and at least one electric contact and solder surface 21b in contact with a P-type layer of the photoelectric conversion material 213. A position of the electric contact and solder surface 21a of the active optical component 21 on the YZ plane is aligned with a position of an electric contact and solder surface 31a of the subsidiary substrate 31 on the YZ plan. A position of the electric contact and solder surface 21b of the active optical component 21 on the YZ plane is aligned with a position of an electric contact and solder surface 31b of the subsidiary substrate 31 on the YZ plane, as shown in FIG. 9A and FIG. 9B.

Step S3: producing a mother substrate unit 30. Refer to FIG. 1 and FIG. 3, the mother substrate unit 30 is made of no light absorption materials and having at least one subsidiary substrate 31. The subsidiary substrates 31 are spaced apart and arranged at the YZ plane in the 3D (XYZ) space to form an array. Along the X-axis, the subsidiary substrate 31 is provided with a first surface 33 and a second surface 34. The first surface 33 is facing the active optical components 21 of the active optical component array unit 20 while the second surface 34 is located opposite to the first surface 33 along the X-axis.

Step S4: performing alignment and positioning of the waveguide array unit 10, the active optical component array unit 20, and the mother substrate unit 30, and connecting and fixing the waveguide array unit 10, the active optical component array unit 20, and the mother substrate unit 30 into one part along the X-axis in the 3D (XYZ) space. Refer to FIG. 1 or FIG. 9C, the first YZ plane 14 is parallel and attached closely to the second YZ plane 24. The optical axis 12 of each of the waveguide members 11 of the waveguide array unit 10 is coupled to the optical axis 22 of each of the active optical components 21 of the active optical component array unit 20 in a one-on-one manner. All gaps between the waveguide array unit 10 and the active optical component array unit 20 are filled completely by a filler 40. An optical index of the filler 40 is larger than an optical index of air and the filler 40 doesn't absorb optical signals of the optical channel 50. Thereby there is no air gap or vacuum gap between the waveguide array unit 10 and the active optical component array unit 20.

Step S5: finishing assembly of the optical communication interconnect device 1 which includes the at least one optical channel 50. The optical channels 50 are spaced apart and arranged at the YZ plane of the 3D (XYZ) space to form an array, as shown in FIG. 1 and FIG. 2.

In practice of semiconductor manufacturing according to the present invention, the step S2 further includes the following steps.

Step S2-1: providing an epitaxial substrate 20a. Refer to FIG. 8, the epitaxial substrate 20a can be a ruby substrate or a sapphire substrate.

Step S2-2: producing an active optical component array unit 20 on the epitaxial substrate 20a by using a semiconductor fabrication process to form a combination body 20b of the epitaxial substrate 20a with the active optical component array unit 20. A boundary surface of both the active optical component array unit 20 and the epitaxial substrate 20a is a plane perpendicular to the X-axis. Refer to FIG. 8, the active optical component array unit 20 includes at least one active optical component 21. The active optical components 21 are spaced apart and arranged at the YZ plane in the 3D (XYZ) space to form an array, as shown in FIG. 4. An optical axis 22 of the respective active optical components 21 is parallel to the X-axis.

In practice of semiconductor manufacturing according to the present invention, the step S3 further includes the following steps.

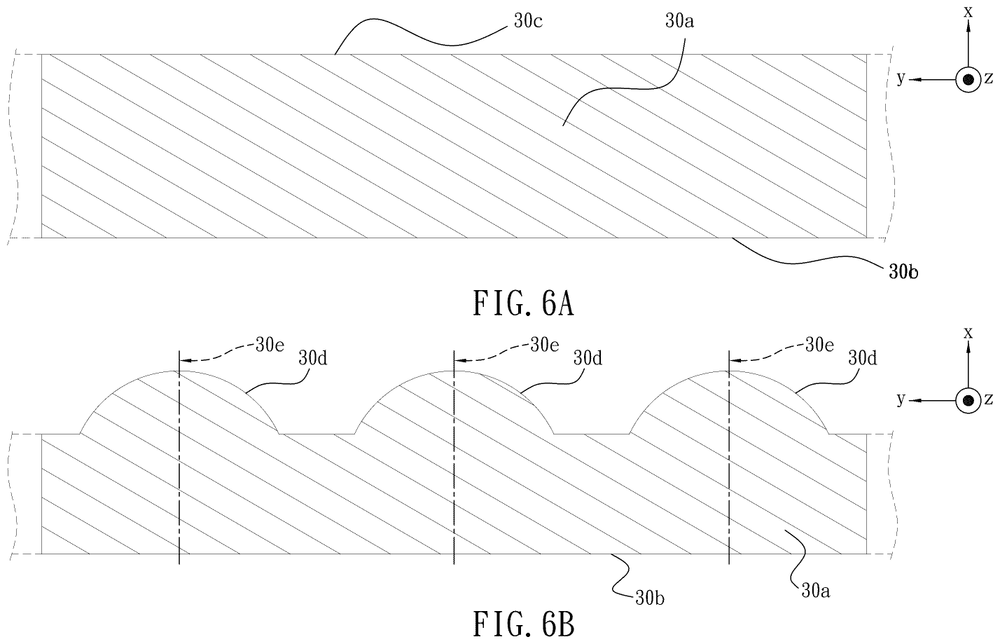

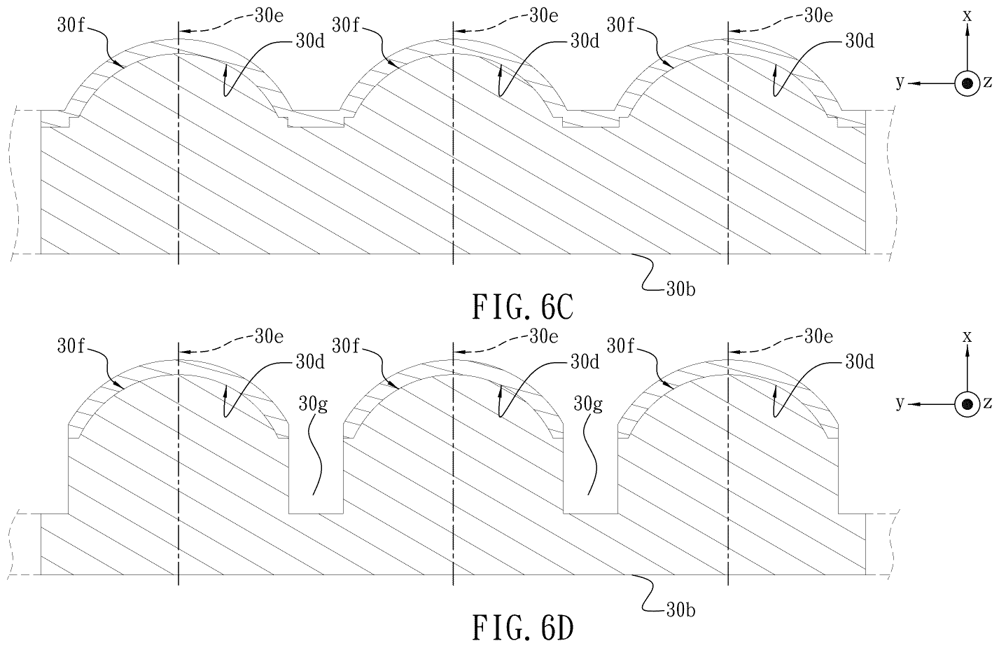

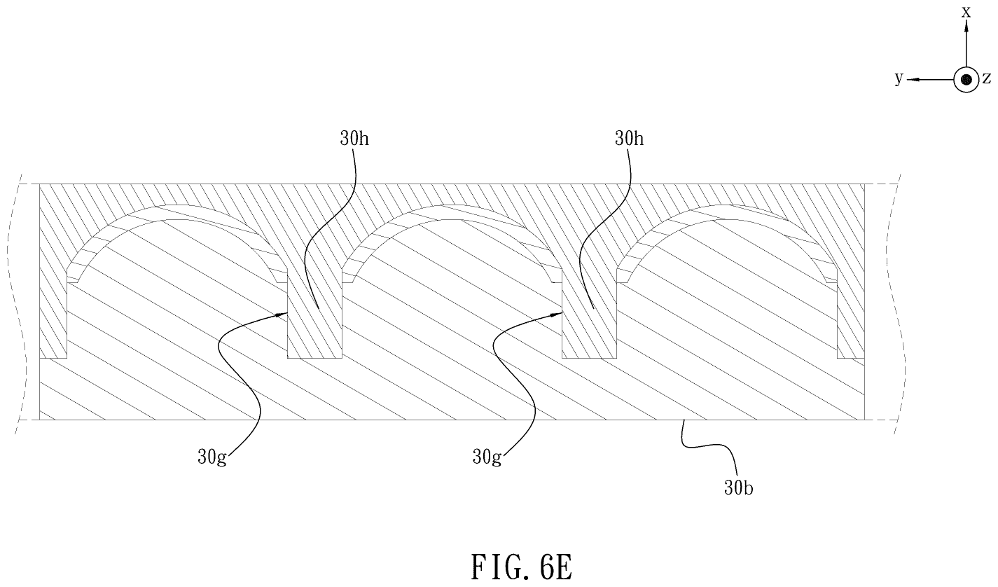

Step S3-1: refer to FIG. 6A, providing a mother substrate body 30a made of no light absorption materials and having a certain thickness in the X-axis in a 3D (XYZ) space. Two sides of the thickness are provided with a first surface 30b extending on the YZ plane and a second surface 30c opposite to the first surface 30b.

Step S3-2: refer to FIG. 6B, producing at least one curved surface 30d on the second surface 30c and arranging the curved surfaces 30d apart from one another on the YZ plane in the 3D (XYZ) space to form an array. An optical axis 30e of the respective curved surfaces 30d is parallel to the X-axis.

Step S3-3: refer to FIG. 6C, coating the respective curved surfaces 30d with reflective materials to form focusing (concave) mirrors 30f. The focusing (concave) mirrors 30f are arranged apart from one another on the YZ plane in the 3D (XYZ) space to form an array.

Step S3-4: refer to FIG. 6D, performing processing to form a first groove 30g with a certain depth between the two adjacent focusing (concave) mirrors 30f. focusing (concave) mirrors 30f.

Step S3-5: refer to FIG. 6E, using light absorption materials to coat and fill the first grooves 30g completely and form a first light absorbing body 30h so that the focusing (concave) mirrors 30f are spaced apart by the first light absorbing bodies 30h to form an array on the YZ plane in the 3D (XYZ) space.

Step S3-6: refer to FIG. 7A, performing processing to form a second groove 30i with a certain depth on the first surface 30b of the mother substrate body 30a and at positions corresponding to the first light absorbing bodies 30h in one-on-one manner. Yet a segment of a communication body 30 of the mother substrate body 30a is kept between the second grooves 30i and the first grooves 30g corresponding to each other in one-on-one manner.

Step S3-7: refer to FIG. 7B, using light absorption materials to coat and fill the second grooves 30i completely and form a second light absorbing body 30k. At least one subsidiary surface 301 is left and formed on the first surface 30b of the mother substrate body 30a. A part of the mother substrate body 30a between the subsidiary surface 301 and the focusing (concave) mirrors 30f corresponding to each other in one-on-one manner is defined as a subsidiary substrate 31. Thereby the subsidiary substrates 31 are spaced apart by the first light absorbing bodies 30h and the second light absorbing bodies 30k to form an array on the YZ plane in the 3D (XYZ) space.

When the active optical component 21 of the active optical component array unit 20 is LED, VCSEL, or PD, the following steps are further included after the step S3-7.

Step S3-8: refer to FIG. 7C, arranging an electric contact and solder surface 31a at the subsidiary surface 301 left and formed on the first surface 30b of the mother substrate body 30a for electrical connection with the electric contact and solder surface 21a of the active optical component 21 of the active optical component array unit 20. Thereby light emitting or light detection of the respective active optical component 21 is achieved.

Step S3-9: refer to FIG. 7D, producing a third groove 30m with a certain depth on the subsidiary surface 301 except the subsidiary surface 301 with the electric contact and solder surfaces 31a. A low-level surface 30n is formed by the third groove 30m. An electric contact and solder surface 31b is disposed on the low-level surface 30n for electrical connection to the electric contact and solder surface 21b of the active optical component 21 in the active optical component array unit 20. Thereby light emitting or light detection of the respective active optical component 21 is achieved.

The step S4 further includes the following steps.

Step S4-1: refer to FIG. 9A, aligning and positioning the combination body 20b having the epitaxial substrate 20a and the active optical component array unit 20, and the mother substrate unit 30 along the X-axis in the 3D (XYZ space) and connecting them into one part. The electric contact and solder surfaces 21a, 21b on the active optical component 21 in the active optical component array unit 20 are electrically connected to the electric contact and solder surfaces 31a, 31b on the subsidiary substrates 31 of the mother substrate unit 30 correspondingly. All the gaps 40a (as shown in FIG. 9B) between the active optical component 21 in the active optical component array unit 20 and the subsidiary substrates 31 of the mother substrate unit 30 are filled completely by a filler 40 which is also used as an adhesive. An optical index of the filler 40 is larger than an optical index of air and the filler 40 doesn't absorb optical signals of respective optical channels 50.

Step S4-2: refer to FIG. 9B, after curing of the filler 40, remove the epitaxial substrate 20a so that one side of the active optical component array unit 20 opposite to the mother substrate unit 30 forms a second YZ plane 24 perpendicular to the X-axis. Thereby the active optical component array unit 20 and the mother substrate unit 30 are adhered and connected by the filler 40 to form a combination body 20, 30. There is s no air gap or vacuum gap between the active optical component array unit 20 and the mother substrate unit 30.

Step S4-3: refer to FIG. 9C, aligning and positioning the waveguide array unit 10 and the combination body 20, 30 of the active optical component array unit 20 with the mother substrate unit 30 along the X-axis in the 3D (XYZ) space and connecting them into one part to form the present optical communication interconnect device 1. The optical axis 12 of the respective waveguide members 11 in the waveguide array unit 10 is coupled to the optical axis 22 of the respective active optical components 21 in the active optical component array unit 20 in one-on-one manner. The first YZ plane 14 is parallel and attached closely to the second YZ plane 24. All gaps between the first YZ plane 14 and the second YZ plane 24 are filled completely by a filler 40. An optical index of the filler 40 is larger than an optical index of air and the filler 40 doesn't absorb optical signals of respective optical channels 50. Thereby there is no air gap or vacuum gap between the waveguide array unit 10 and the active optical component array unit

Step S4-4: finishing assembly of the optical communication interconnect device 1 after the waveguide array unit 10 and the combination body 20, 30 of the active optical component array unit 20 with the mother substrate unit 30 being connected into one part and fixed.

Step S4 further includes the following steps.

Step S4-5: using an optical axis alignment mechanism for alignment and positioning of the optical axes 12 of the respective waveguide members 11 in the waveguide array unit 10 and optical axes 22 of the respective active optical components 21 while the optical axes 12 and the optical axes 22 are coupled in one-on-one manner.

Step S4-6: detecting positions of a normal line of the first YZ plane 14 and a normal line of the second YZ plane 24 skew to each other during alignment and positioning of the waveguide array unit 10 and the active optical component array unit 20

Step S4-7: giving information of the positions of the two normal lines skew to each other to the optical axis alignment mechanism as feedback to make the first YZ plane 14 and the second YZ plane 24 become more parallel to each other. Thereby the first YZ plane 14 and the second YZ plane 24 are getting closer to each other.

Refer to FIG. 1 and FIG. 2, in practice of semiconductor manufacturing according to the present invention, a magnetic alignment array is arranged at an outer edge 331 of a plane on one side of the mother substrate unit 30 facing the active optical component array unit 20 and including at least one alignment key (magnetic member) M3 in order to complete alignment of the optical communication interconnect device 1. Take an embodiment shown in FIG. 3 as an example, but not intend to limit the present invention. The magnetic alignment array includes four alignment keys (magnetic member) M3 located at different positions (having different YZ coordinates). A magnetic alignment array is disposed on an outer edge 241 of a plane on one side of the active optical component array unit 20 facing the mother substrate unit 30 and including at least one alignment key (magnetic member) M4. Take an embodiment shown in FIG. 4 as an example, but not intend to limit the present invention. The magnetic alignment array includes four alignment keys (magnetic member) M4 located at different positions (having different YZ coordinates). The alignment keys (magnetic member) M3 are arranged correspondingly to the alignment keys (magnetic member) M4 in one-on-one manner but the alignment keys (magnetic member) M3, M4 have opposite magnetic poles. Thereby magnetic attraction between the alignment keys (magnetic member) M3, M4 helps precise alignment between the electric contact and solder surfaces 21a, 21b on the active optical component 21 and the electric contact and solder surfaces 31a, 31b on the subsidiary substrates 31 in one-on-one manner.

Refer to FIG. 3, the mother substrate unit 30 is extending outward from an area with the subsidiary substrates 31 having optical axes in Y, Z directions to form an extension plane 331 facing the active optical component array unit 20. The extension plane 331 is provided with at least one alignment keys (magnetic member) M3 made of magnetic materials. Refer to FIG. 4, the active optical component array unit 20 is extending outward from an area with the active optical components 21 in Y, Z directions to form an extension plane 241 facing the mother substrate unit 30. The extension plane 241 is provided with at least one alignment keys (magnetic member) M4 made of magnetic materials. The alignment keys (magnetic member) M3, M4 having opposite magnetic poles which attract each other. When the alignment keys (magnetic member) M3 on the extension plane 331 are aligned with the alignment keys (magnetic member) M4 on the extension plane 241 in (Y, Z) coordinates, the electric contact and solder surfaces 21a, 21b on the active optical component 21 and the electric contact and solder surfaces 31a, 31b on the subsidiary substrates 31 are aligned with each other.

Refer to FIG. 1, FIG. 2, FIG. 5A, and FIG. 5B, in practice of semiconductor manufacturing according to the present invention, a magnetic alignment array is arranged at an outer edge 24a of the second YZ plane 24 of the active optical component array unit 20 facing the waveguide array unit 10 in order to complete alignment of the optical communication interconnect device 1. The magnetic alignment array includes at least one alignment keys (magnetic member) M5. Take an embodiment shown in FIG. 5A as an example, but not intend to limit the present invention. The magnetic alignment array includes four alignment keys (magnetic member) M5 located at different YZ coordinates. A magnetic alignment array is also disposed on an outer edge 14a of the first YZ plane 14 of the waveguide array unit 10 facing the active optical component array unit 20. The magnetic alignment array includes at least one alignment keys (magnetic member) M6. Take an embodiment shown in FIG. 5B as an example, but not intend to limit the present invention. The magnetic alignment array includes four alignment keys (magnetic members) M6 located at different YZ coordinates. The alignment keys (magnetic members) M5 are arranged correspondingly to the alignment keys (magnetic member) M6 in one-on-one manner but the alignment keys (magnetic member) M5, M6 have opposite magnetic poles. Thereby magnetic attraction between the alignment keys (magnetic members) M5, M6 helps precise alignment of the optical axis 12 of the respective waveguide member 11 with the optical axis 22 of the respective active optical components 21 while the optical axis 12 and the optical axis 22 are coupled in one-on-one manner.

Refer to FIG. 5A, the second YZ plane 24 of the active optical component array unit 20 is extending outward from an area with the active optical components 21 in Y, Z directions to form an extension plane 24a which is provided with at least one alignment key M5 made of magnetic materials. Refer to FIG. 5B, the first YZ plane 14 of the waveguide array unit 10 is extending outward from an area with the waveguide members 11 in Y, Z directions to form an extension plane 14a which is provided with at least one alignment key M6 made of magnetic materials. The alignment keys M5, M6 have opposite magnetic poles which attract each other. When the alignment keys M5 on the extension plane 24a is aligned with the alignment keys M6 on the extension plane 14a in (Y, Z) coordinates, the optical axes 12 of the waveguide members 11 and the optical axes 22 of the active optical components 21 in the active optical component array unit 20 are also aligned with each other.

The active optical component array unit 20 and the mother substrate unit 30 according to the present invention can be produced by semiconductor process. Thus the present optical communication interconnect device 1 not only can have more light channels by wafer level packaging, the volume of the optical interconnect device is significantly reduced. The packaging stability is also improved because that the wire bonding process of the electric contact and solder surfaces is avoided.

Other technical features and functions of the present optical communication interconnect device 1 are briefly described as follows. At first the active optical components 21 of the active optical component array unit 20 are closely attached to the waveguide members 11 of the waveguide array unit 10. When the active optical components 21 is a light emitting component, light emitted from the light emitting component in the negative X-direction (−X) has a quite large solid angle while entering the corresponding waveguide member 11. When the active optical components 21 is an optical receiver, light emitted from the waveguide member 11 in the negative X-direction (−X) has a quite large solid angle while entering the corresponding optical receiver. Next when the active optical components 21 is a light emitting component, light emitted from the light emitting component in the positive X-direction (+X) has a quite large solid angle after being focused by the focusing mirror 35 and then entering the corresponding waveguide member 11 of the waveguide array unit 10. Moreover, when the active optical components 21 is a light emitting component, light emitted from the light emitting component to the adjacent light channels 50 is absorbed by the light absorption bodies 60 or 60a made of light absorption materials, without entering the adjacent light channels 50 relatively and causing cross talk.

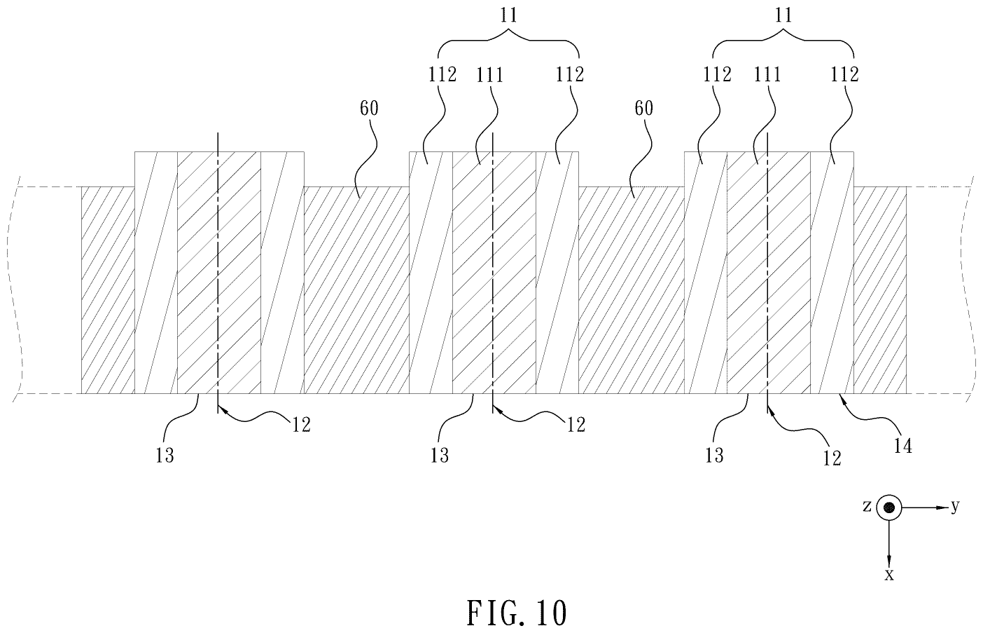

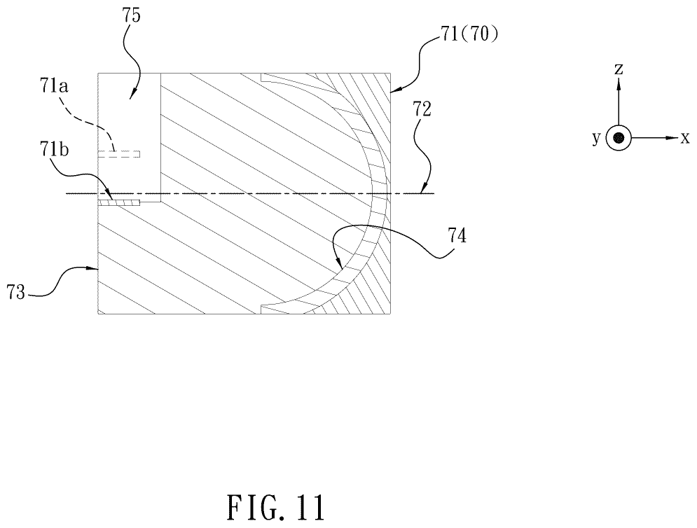

Refer to FIG. 10, when the waveguide member 11 of the waveguide array unit 10 is optical fiber, the waveguide member 11 includes a core 111 and a cladding layer 112 surrounding the core 111. The light absorption body 60a made of light absorption materials (such as light absorption ceramic) is mounted between the waveguide members 11. The optical axes 12 of the waveguide members 11 are parallel to the X-axis and the surfaces 13 on the side of the waveguide members 11 facing the active optical component array unit 20 (FIG. 1) form the first YZ plane 14 perpendicular to the X-axis. That means the first YZ plane 14 is perpendicular to the X-axis and the optical axes 12 of the waveguide members 11.

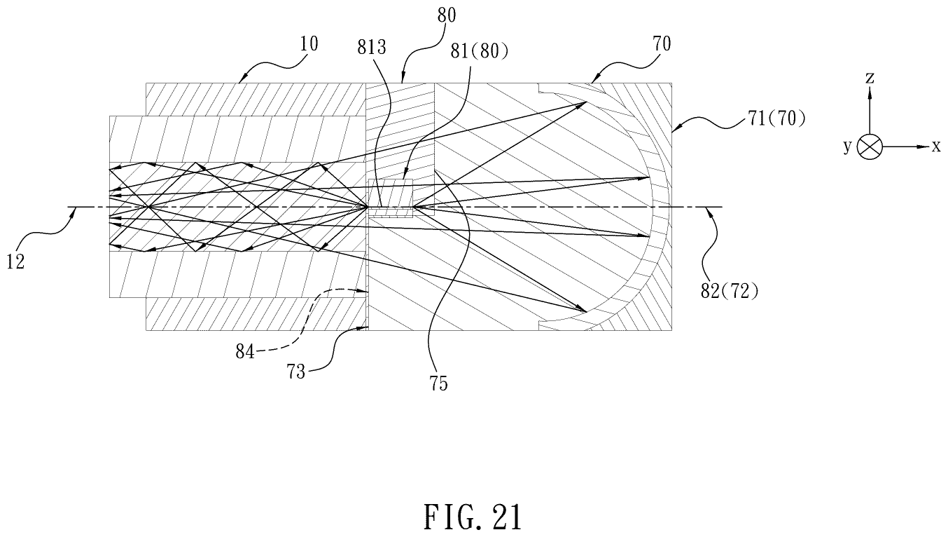

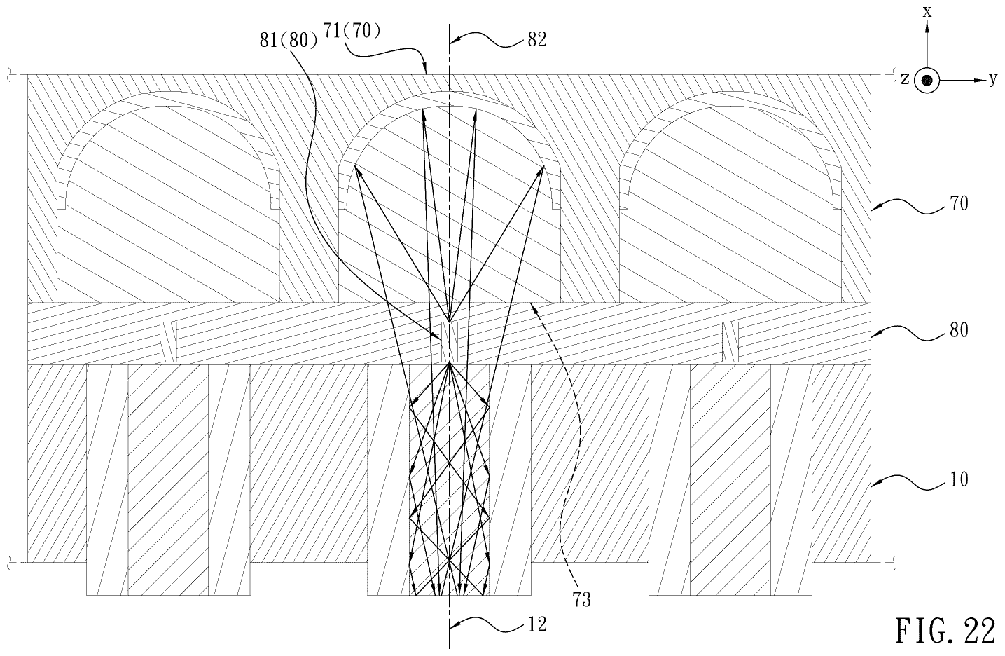

When each of the active optical components 21 is an edge emitting semiconductor light source, the present optical communication interconnect device 1 includes the at least one optical channel 50. The optical channels 50 are spaced apart and arranged at the YZ plane in the 3D (XYZ) space to form a 1-diemsnional array. The structure type of the active optical component array unit 20 and a connection type of the active optical component array unit 20 with the mother substrate unit 30 are different from those of the active optical component array unit 20 which is a surface emitting semiconductor light source (as shown in Fig, 1, FIG. 8, FIG. 9A, and FIG. 9B). Yet both have the same technical features. Refer to FIG. 11-22 one by one, structure type of the active optical component array unit 20 and a connection type of the active optical component array unit 20 with the mother substrate unit 30 are described when the active optical components 21 are edge-emitting semiconductor light sources. Only difference in the structure type is described.

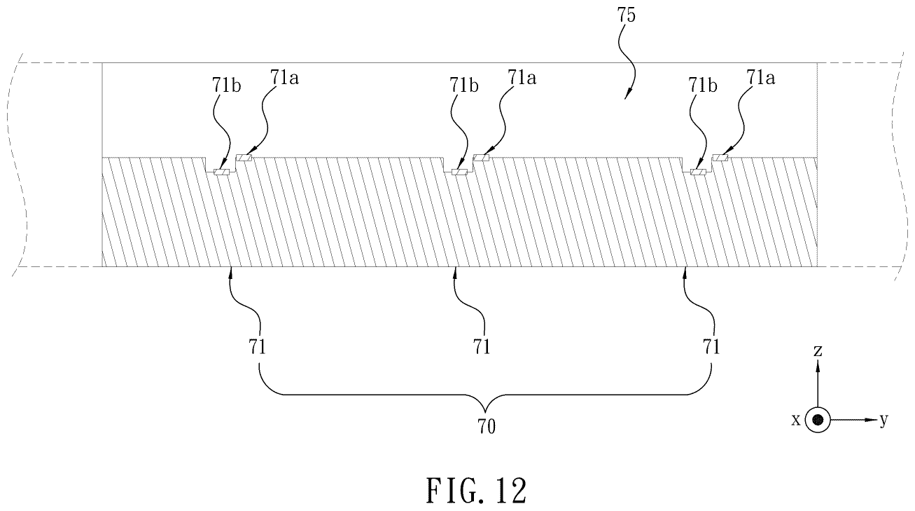

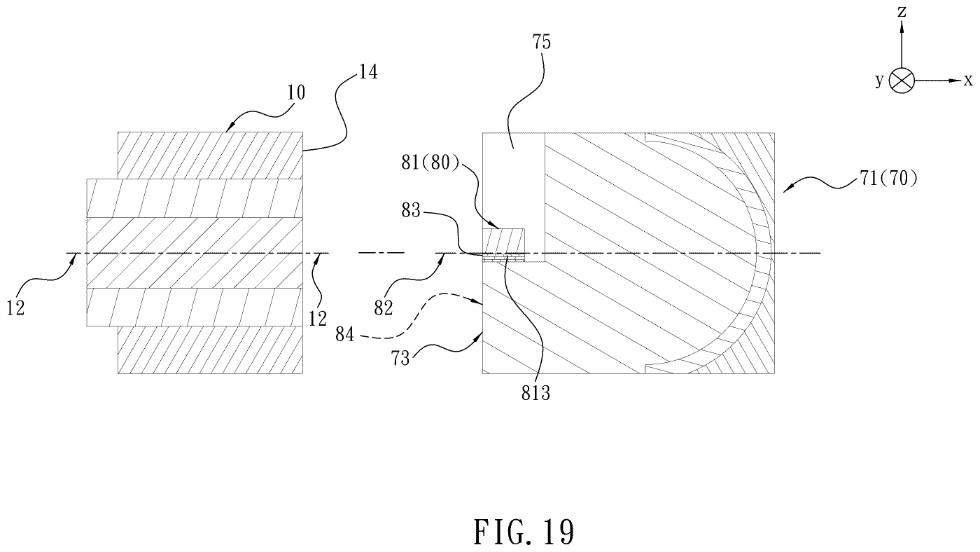

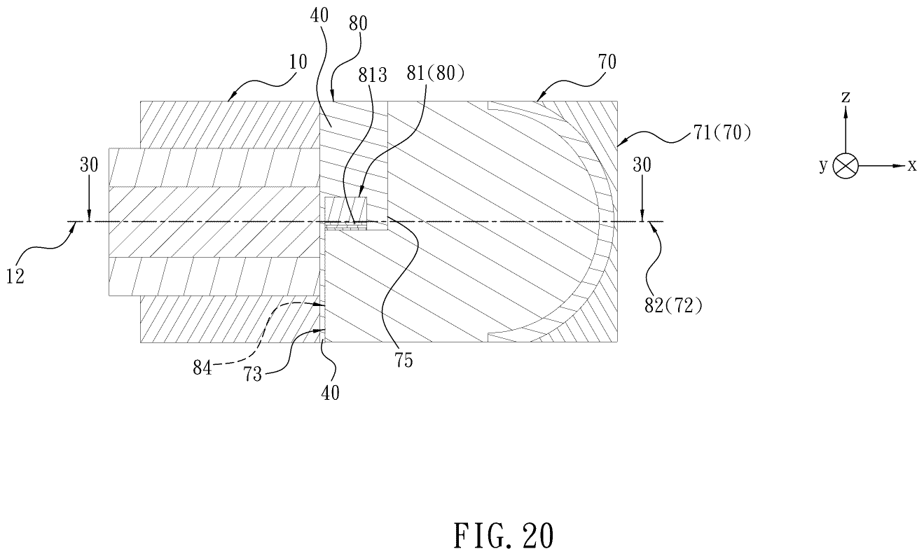

Refer to FIG. 11 and FIG. 12, a mother substrate unit 70 includes at least one subsidiary substrate 71 which are spaced apart and arranged at the YZ plane in the 3D (XYZ) space to form a one-dimensional array. A focusing mirror of the subsidiary substrate 71 is provided with an optical axis 72, a first surface 73 and a second surface 74 both in the X-axis. As shown in FIG. 19 and FIG. 20, the first surface of the respective subsidiary substrates 71 is close to active optical components 81 of an active optical component array unit 80. The second surface 74 is located at one side opposite to the first surface 73 in the X-axis to form the focusing mirror (the same as the focusing mirror 35 shown in FIG. 9A). A groove 75 is formed on the first surface 73 and a plurality of electric contact and solder surfaces 71a (the same as the electric contact and solder surfaces 31a shown in FIG. 7D) and a plurality of electric contact and solder surfaces 71b corresponding to the electric contact and solder surfaces 71b (the same as the electric contact and solder surfaces 31b shown in FIG. 7D) are disposed on a bottom surface of the groove 75 in Y-axis and spaced apart from one another.

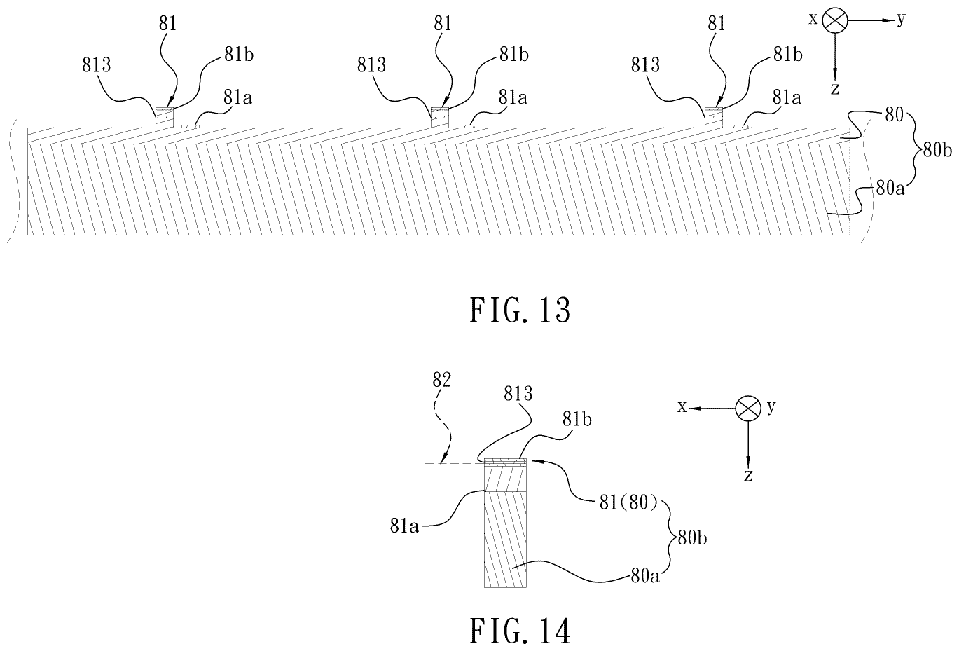

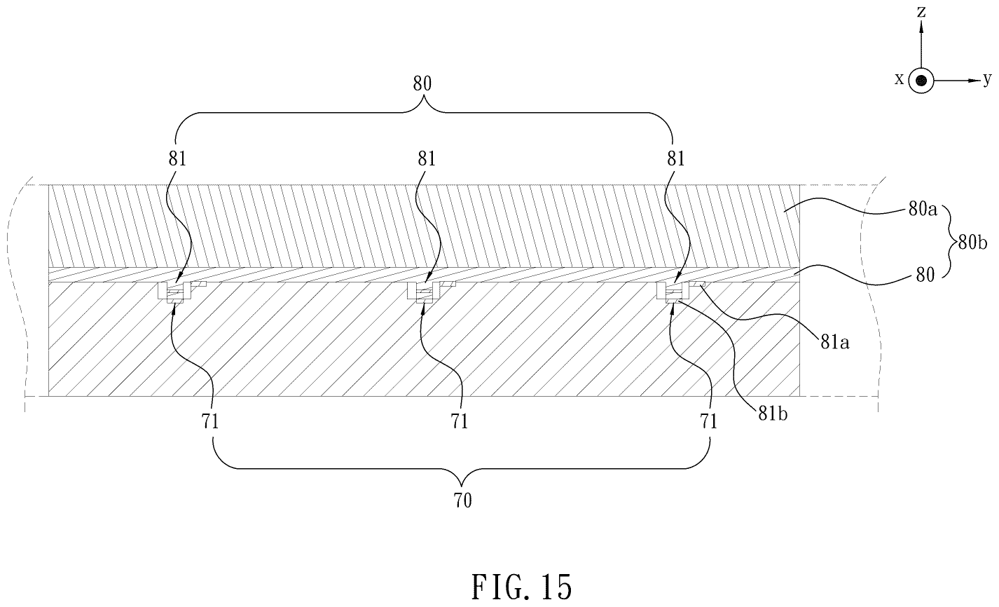

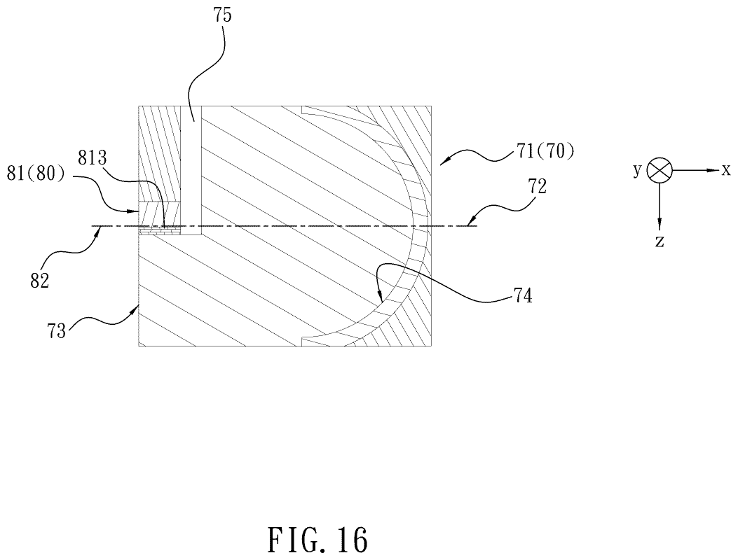

Refer to FIG. 13 and FIG. 14, an epitaxial substrate 80a (the same as the epitaxial substrate 20a shown in FIG. 8) is produced on an active optical component array unit 80 (the same as the active optical component array unit 20 shown in FIG. 8) of an edge emitting semiconductor light source by a semiconductor manufacturing process. Thus a combination body 80b (the same as the combination body 20b shown in FIG. 8) of the epitaxial substrate 80a with the active optical component array unit 80 is formed. The he active optical component array unit 80 includes at least one active optical component 81. The respective active optical components 81 are spaced apart and arranged at the YZ plane in the 3D (XYZ) space to form a one-dimensional array, as shown in FIG. 13. An optical axis 82 of the active optical component 81 (the same as the optical axis 22 of the active optical component 20 shown in FIG. 1) is parallel to the X-axis, as shown in FIG. 14. The active optical component 81 includes a photoelectric conversion material 813, and electric contact and solder surfaces 81a, 81b. As shown in FIG. 15 and FIG. 16, the combination body 80 is fixed and connected to the groove 75 on the first surface 73 of the subsidiary substrate 71 (as shown in FIG. 9A or step S4-1). Thus the electric contact and solder surfaces 81a, 81b of the active optical component 81 and the electric contact and solder surfaces 71a, 71b of the subsidiary substrate 71 are connected correspondingly. Thereby the active optical component 81 can emit light.

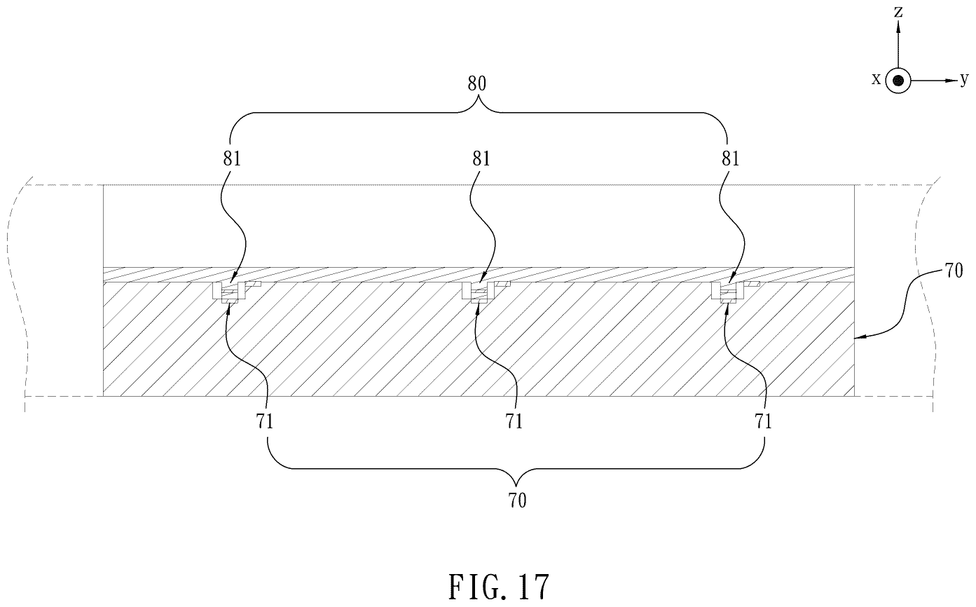

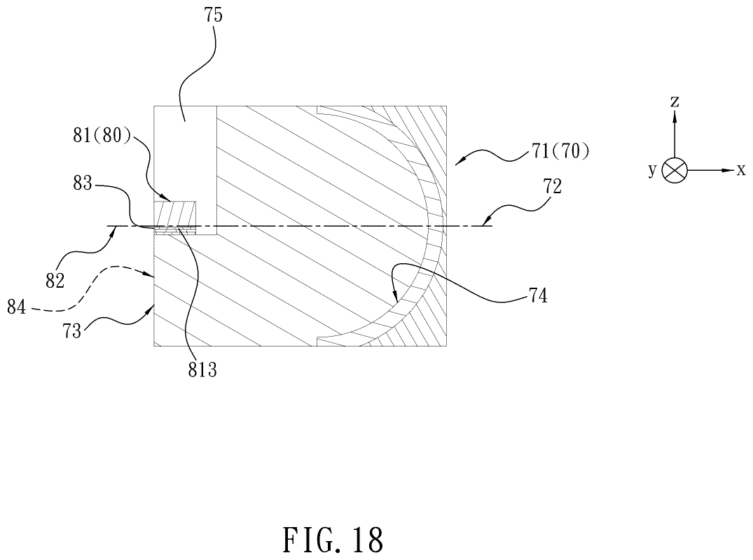

Refer to FIG. 17 and FIG. 18, remove the epitaxial substrate 80a from the combination body 80b so that the active optical component array unit 80 and the mother substrate unit 70 are aligned with and positioned relative to each other along the X-axis in the 3D (XYZ) space and further connected to one part (as shown in FIG. 9A). The optical axis 82 of the active optical component 81 is coupled to the optical axis 72 of the focusing mirror on the subsidiary substrate 71 in one-on-one manner. A light emitting side 83 of the edge emitting semiconductor light source of the active optical component 81 is flush with the first surface 73 of the subsidiary substrate 71, which is defined as a second YZ plane 84 (as the second YZ plane 24 shown in FIG. 1). That means the second YZ plane 84 is perpendicular to the X-axis and the optical axis 82 of the active optical component 81.

Refer to FIG. 19 and FIG. 20, a waveguide array unit 10 and the combination body (80, 70) of the active optical component array unit 80 with the mother substrate unit 70 are aligned with and positioned relative to each other along the X-axis in the 3D (XYZ) space and further connected to one part to form another embodiment of the present optical interconnect device (as shown in FIG. 9C or step S 4-3). The optical axes 12 of the respective waveguide members 11 are coupled to the optical axis 82 of the active optical component 81 and the optical axes 72 of the focusing mirror on the subsidiary substrate 71 in one-on-one manner. The first YZ plane 14 is parallel and attached closely to the second YZ plane 84 and all gaps between the first YZ plane 14 and the second YZ plane 84, including a space of the groove 75 formed on the mother substrate unit 70, is filled completely with a filler 40 which is also used as an adhesive. An optical index of the filler 40 is larger than an optical index of air. The filler 40 doesn't absorb optical signals of respective optical channels 50. Thereby there is no air gap or vacuum gap among the waveguide array unit 10, the active optical component array unit 80, and the mother substrate unit 70.

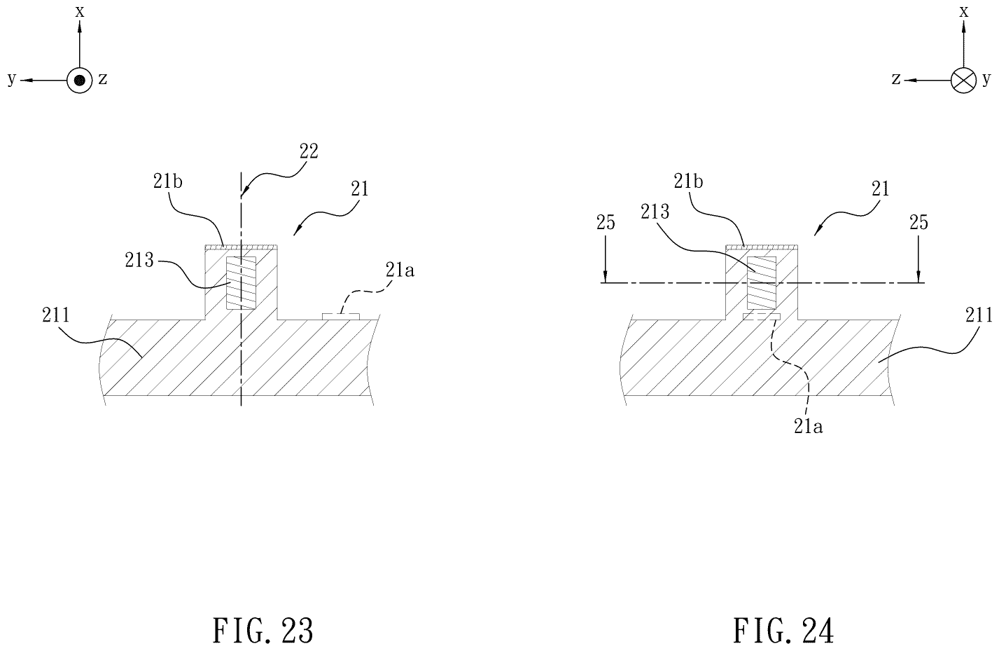

During transmission, a light beam is bound to spread and distribute sideways such as Gaussian beam, or light diffusion of a point light source. Thus a focusing mirror is needed to be arranged between the light source and the waveguide of a conventional optical communication interconnect device for focusing the diffused light from the light source into a core of the waveguide. As to the present optical communication interconnect device 1, most of light emitted from the photoelectric conversion material 213 or 813 of the active optical component 21 or 81 is unable to enter into the core 111 of the waveguide member 11 for transmission once a width of a YZ section of the photoelectric conversion material 213 or 813 of the active optical component 21 or 81 is larger than a width of a YZ section of the core 111 of the waveguide member 11 (light source end). Thus during design of the present optical communication interconnect device 1, when the active optical component 21 or 81 is the light source end, there should be a special design to make the width of the YZ section of the photoelectric conversion material 213 or 813 of the active optical component 21 or 81 become smaller than the width of the YZ section of the core 111 of the waveguide member 11. Thereby the optical coupling efficiency of the present optical communication interconnect device 1 is improved. Refer to FIG. 23-29, the related details are as follows.

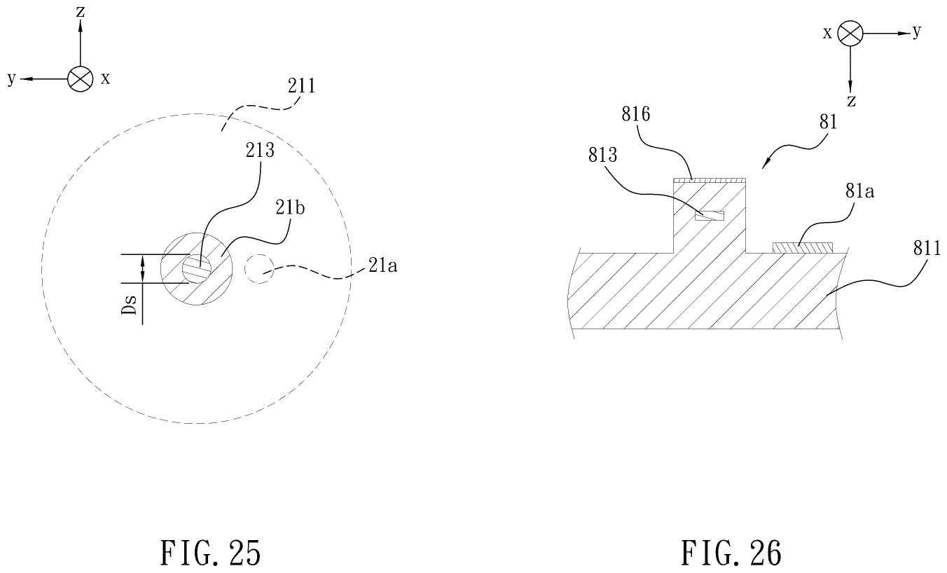

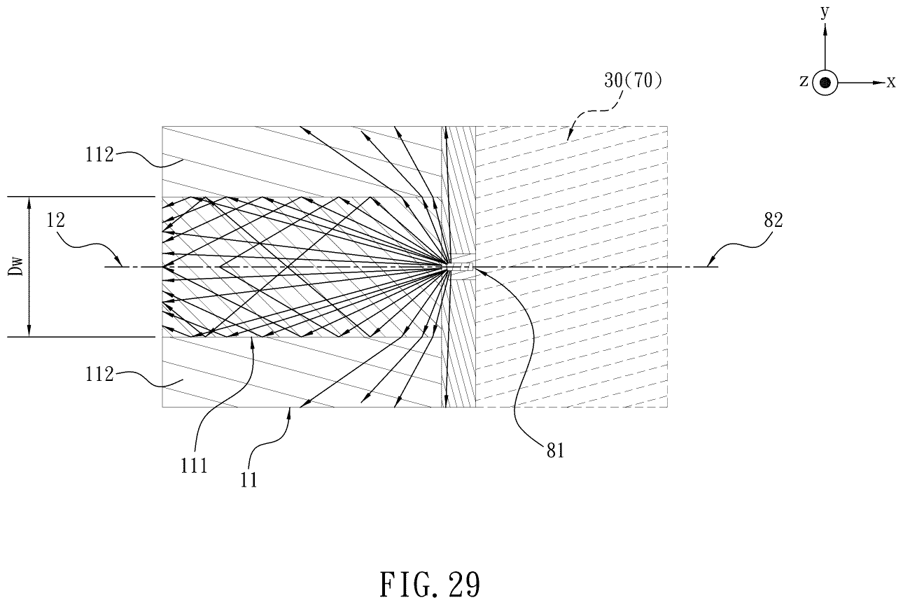

Refer to FIG. 23-25, FIG. 23 is a partial enlarged schematic drawing of the XY plane of the active optical component 21 shown in FIG. 8. The active optical component 21 is a surface emitting light source chip such as LED or VCSEL, but not limited. The active optical component 21 includes an optical axis 22 which is provided with a surface emitting light source chip 211, photoelectric conversion material 213 (PN junction), and electric contact and solder surfaces 21a, 21b, as shown in FIG. 23 and FIG. 24. Generally, the photoelectric conversion material 213 on the YZ section is circular, as shown in FIG. 25. According to the design of the present invention, a width Ds of the YZ section of the photoelectric conversion material 213 of the active optical component 21 is especially selected or designed to be smaller than a width Dw of the YZ section of the core 111 of the corresponding waveguide member 11, as shown in FIG. 29. Most of light emitted from the photoelectric conversion material 213 of the active optical component 21 is entering the core 111 of the waveguide member 11 to be transmitted therein, as shown in FIG. 29. Thereby the optical coupling efficiency is improved.

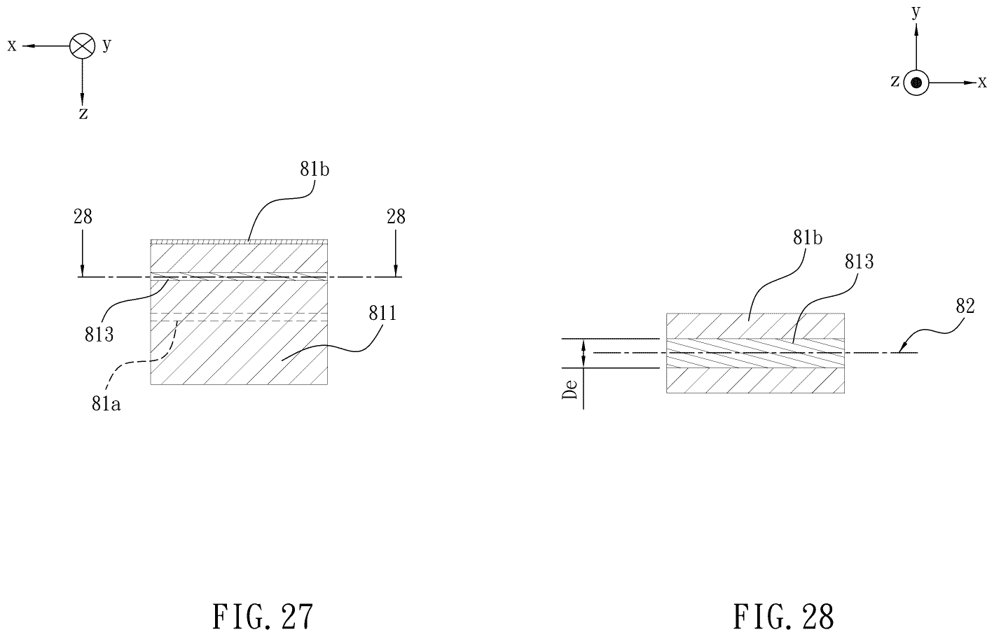

Refer to FIG. 26-28, FIG. 26 is a partial enlarged schematic drawing of the XY plane of the active optical component 81 shown in FIG. 13. The active optical component 21 is an edge emitting light source chip such as FP laser, DFB laser, or distributed Bragg reflector (DBR) laser. The active optical component 81 includes an optical axis 82 which is provided with an edge emitting light source chip 811, photoelectric conversion material 813 (PN junction), and electric contact and solder surfaces 81a, 81b, as shown in FIG. 26 and FIG. 27. Generally, the photoelectric conversion material 813 on the YZ section is rectangular, as shown in FIG. 26. A width of the section in the Y-axis is larger while a width of the section in the Z-axis is smaller. The light is mainly emitted along the X-axis and −X-axis. According to the design of the present invention, a width De of the YZ section of the photoelectric conversion material 813 of the active optical component 81 is especially selected or designed to be smaller than a width Dw of the YZ section of the core 111 of the corresponding waveguide member 11, as shown in FIG. 29. Most of light emitted from the photoelectric conversion material 813 of the active optical component 81 is entering the core 111 of the waveguide member 11 to be transmitted therein, as shown in FIG. 29. Thereby the optical coupling efficiency of the present optical communication interconnect device 1 is increased.

Refer to FIG. 30A, 30B which are sections along a line 30-30 of the embodiment in FIG. 20 (XZ plane) with reference signs changed into the embodiment shown in FIG. 1 or FIG. 5A, 5B, they are used to explain how the first YZ plane 14, the second YZ plane 24, and their extension surfaces 14a, 24a are defined. In the present optical communication interconnect device 1, the surface 23 formed at the side of the active optical component 21 facing the waveguide array unit 10 may be corrugated in a broad sense, as shown in FIG. 30A. Thus in the present invention, the plane in the surface 23 at the side the closest to the waveguide array unit 10 and perpendicular to the X-axis is defined as the second YZ plane 24, as shown in FIG. 30B. Similarly, the surface 13 formed at the side of the waveguide member 11 facing the active optical component array unit 20 may also be corrugated in a broad sense, as shown in FIG. 30A 04 FIG.

31A and FIG. 31B. Thus the present invention defines the plane in the surface 13 at the side closest to the active optical component array unit 20 and perpendicular to the X-axis is defined as the first YZ plane 14, as shown in FIG. 30B. The surface 13 shown in FIG. 30A doesn't especially show corrugated shape so that the surface 13 shown in FIG. 30A is almost equal to the first YZ plane 14 shown in FIG. 30B.

Refer to FIG. 30A, 30B, together with FIG. 5A, 5B, and related description, in order to help finishing the alignment of the optical communication interconnect device 1, the second YZ plane 24 of the active optical component array unit 20 is extending outward from an area with the active optical components 21 in Y, Z directions to form a second extension plane 24a. At least one alignment key M5 made of magnetic materials is disposed on the second extension plane 24a. Refer to FIG. 30B, the first YZ plane 14 of the waveguide array unit 10 is extending outward from an area with the waveguide members 11 in Y, Z directions to form a first extension plane 14a. At least one alignment key M6 (not shown in figure) made of magnetic materials is arranged at the first extension plane 14a. The alignment keys M5, M6 have opposite magnetic poles which attract each other. When the alignment keys M5 on the second extension plane 24a is aligned with the alignment keys M6 on the first extension plane 14a (Y, Z) coordinates, the optical axes 12 of the waveguide members 11 in the waveguide array unit 10 and the optical axes 22 of the active optical components 21 in the active optical component array unit 20 are also aligned with each other. This helps manufacturing and alignment of the semiconductor of the present invention in practice.

Refer to FIG. 31A, 31B, the waveguide array unit 10 is extending outward from an area with the waveguide members 11 in Y, Z directions to form a first extension plane 14a which is further used as the first YZ plane. Thereby the surface 13 on the area with the waveguide members 11 in the waveguide array unit 10 is away from the side of the active optical component 21 a certain distance compared with the first extension plane 14a. Therefore, damages of the active optical components 21 caused by collisions between the waveguide array unit 10 and the active optical component array unit 20 during alignment and positioning of the waveguide array unit 10 and the active optical component array unit 20 can be avoided. Similarly, (but not shown in figure), the active optical component array unit 20 is extending outward from an area with the active optical components 21 in Y, Z directions to form a second extension plane 24a which is further used as the second YZ plane 24. Thereby the surface 23 on the area with the active optical components 21 in the active optical component array unit 20 is away from the side of the waveguide members 11 a certain distance compared with the second extension plane 24a. Therefore, damages of the active optical components 21 caused by collisions between the waveguide array unit 10 and the active optical component array unit 20 during alignment and positioning of the waveguide array unit 10 and the active optical component array unit 20 can be avoided.

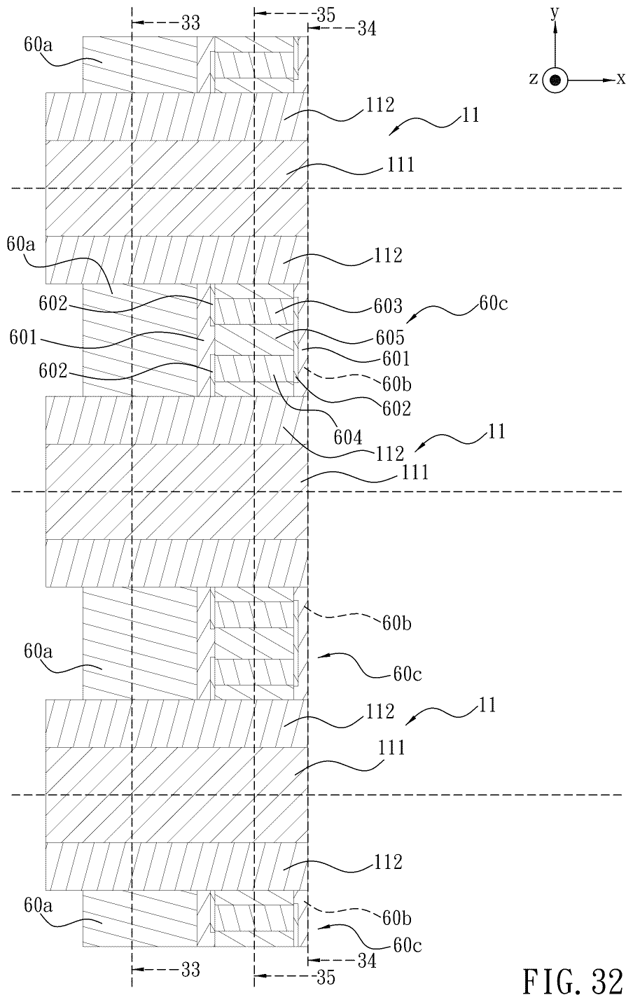

Refer to FIG. 32 and FIG. 34, the light absorption body 60a arranged between the two adjacent waveguide members 11 in the waveguide array unit 10 and facing one end of the active optical component array unit 20 is made of thermally conductive materials 60b with higher thermal conductivity. The thermally conductive materials 60b include diamond, aluminum nitride, silicon carbide, and graphite, but not limited. Thereby heat is transferred from the active optical components 21 and lighting quality of the active optical components 21 is ensured.

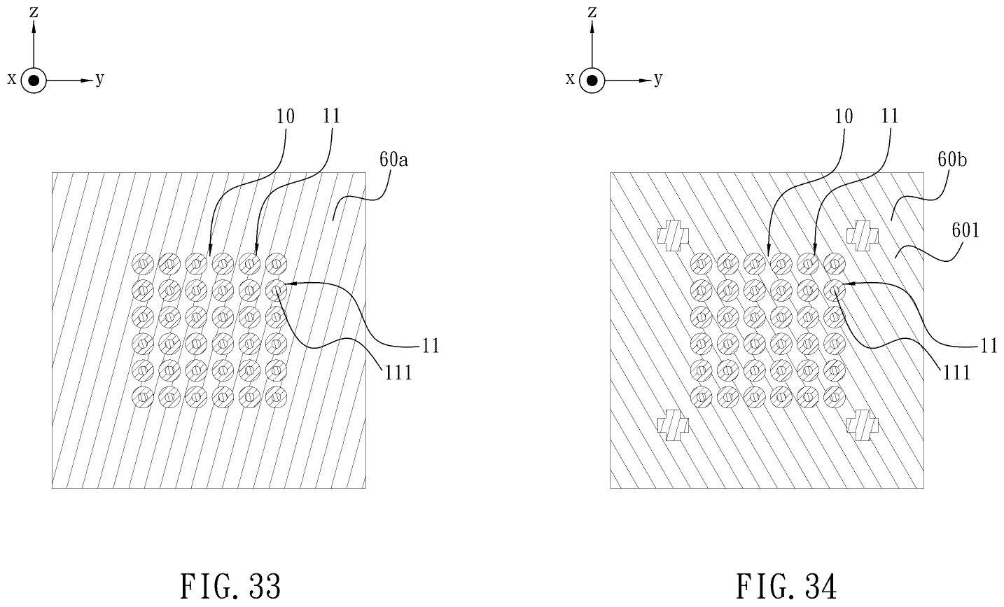

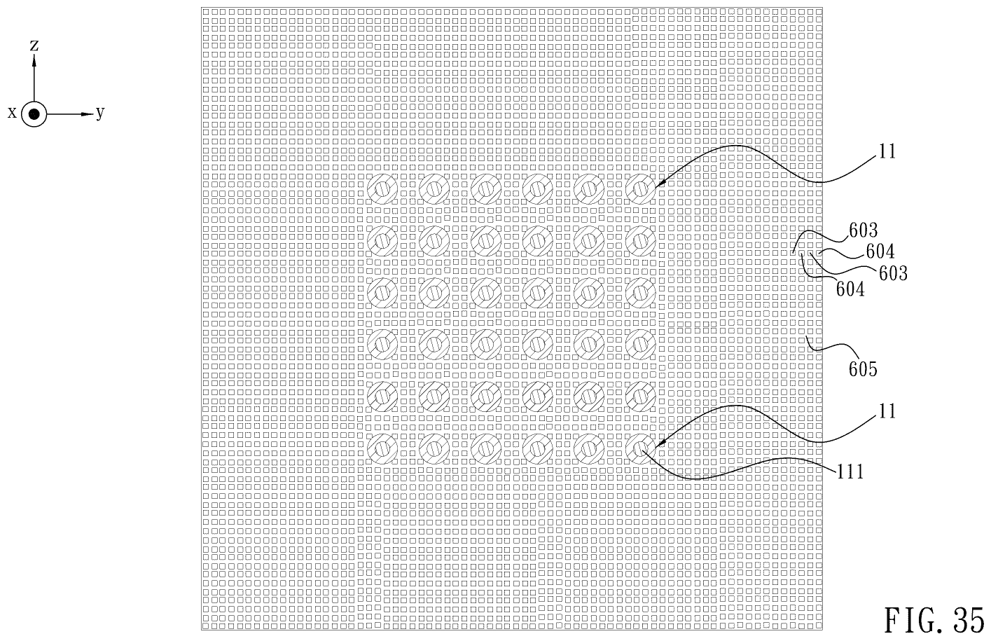

Refer to FIG. 32-35, the light absorption body 60a arranged between the two adjacent waveguide members 11 in the waveguide array unit 10 and facing one end of the active optical component array unit 20 is formed by thermal electric (TE) cooler 60c. Thereby the temperature of the active optical components 21 is under control of the TE cooler 60c to ensure lighting quality of the active optical components 21. The TE cooler 60c is formed by two thermally conductive material layers 601 arranged apart from each other in X-axis (as shown in FIG. 34), two electrically conductive material layers 602 attached to an inner side of the two thermally conductive material layers 601 correspondingly, a plurality of p-type electrodes 603 and n-type electrodes 604 mounted between the two electrically conductive material layers 602 in a spaced manner (as shown in FIG. 35), and an insulating material layer 605 filled into gaps between the p-type electrodes 603 and the n-type electrodes 604 (as shown in FIG. 35). The TE cooler is a known technique and no further details are provided.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalent.

1. An optical communication interconnect device comprising: a waveguide array unit, an active optical component array unit, and a mother substrate unit in turn along the X-axis in a 3-dimensional (XYZ) space; the waveguide array unit, the active optical component array unit, and the mother substrate unit aligned with and positioned relative to one another and connected to form one part;
wherein the waveguide array unit includes at least one waveguide member; the waveguide members are spaced apart and arranged at the YZ plane in a 3D (XYZ) space to form an array and an optical axis of each of the waveguide members is parallel to the X-axis; wherein a plane on a surface of one side of the waveguide member facing the active optical component array unit, located closest to the active optical component array unit, and perpendicular to the X-axis is defined as a first YZ plane; the first YZ plane is perpendicular to the X-axis and the optical axes of the waveguide members;
wherein the active optical component array unit includes at least one active optical component; the active optical components are spaced apart and arranged at the YZ plane in the 3D (XYZ) space to form an array and an optical axis of each of the active optical components is parallel to the X-axis; wherein a plane on a surface of one side of the active optical component array unit facing the waveguide array unit, located closest to the waveguide array unit, and perpendicular to the X-axis is defined as a second YZ plane; the second YZ plane is perpendicular to the X-axis and the optical axis of each of the active optical components;
wherein the mother substrate unit includes at least one subsidiary substrate; the subsidiary substrates are spaced apart and arranged at the YZ plane in the 3D (XYZ) space to form an array; wherein each of the subsidiary substrates is provided with a position reference axis parallel to the X-axis; the subsidiary substrate includes a first surface and a second surface along the X-axis; wherein the first surface is facing and close or connected to the active optical component of the active optical component array unit while the second surface is located opposite to the first surface along the X-axis; wherein the first YZ plane is parallel and attached closely to the second YZ plane and gaps between the first YZ plane and the second YZ plane is filled completely by a filler so that there is no air gap or vacuum gap between the waveguide array unit and the active optical component array unit; wherein an optical axis of each of the waveguide members in the waveguide array unit is coupled to both the optical axis of each of the active optical components in the active optical component array unit and the position reference axis of each of the subsidiary substrates in the mother substrate unit in one-on-one manner so that the waveguide members, the active optical components, and the subsidiary substrates are connected in turn along the X-axis to form an optical channel; thereby the optical communication interconnect device includes the at least one optical channel and the optical channels are spaced apart and arranged at the YZ plane in the 3D (XYZ) space to form an array.

2. The optical communication interconnect device as claimed in claim 1, wherein gaps between the active optical component and the subsidiary substrate are filled fully by a filler and an optical index of the filler is larger than an optical index of air so that there is no air gap or vacuum gap between the active optical component and the subsidiary substrate; thus the waveguide member, the active optical component, and the subsidiary substrate are connected to form a light channel without any air gap or vacuum gap.

3. The optical communication interconnect device as claimed in claim 1, wherein the filler includes a gel filler and a liquid filler; an optical index of the filler is larger than an optical index of air.

4. The optical communication interconnect device as claimed in claim 3, wherein the optical index of the filler is between an optical index of a core of the waveguide member and an optical index of a photoelectric conversion material of the active optical component.

5. The optical communication interconnect device as claimed in claim 1, wherein when the filler is a gel filler, the gel filler is used as an adhesive so that the waveguide array unit and the active optical component array unit are positioned relative to each other and connected to form one part after curing of the adhesive.

6. The optical communication interconnect device as claimed in claim 1, wherein when the filler is a liquid filler, a housing is disposed around and tightly covering gaps between the waveguide array unit and the active optical component array unit so that the liquid filler is freely flowing in a space inside the housing including all of the gaps between the waveguide array unit and the active optical component array unit.

7. The optical communication interconnect device as claimed in claim 1, wherein materials for the subsidiary substrate include semiconductors, glass, acrylic, and ceramic.

8. The optical communication interconnect device as claimed in claim 1, wherein materials for the subsidiary substrate and the active optical component include semiconductors, glass, acrylic, and ceramic.

9. The optical communication interconnect device as claimed in claim 1, wherein a mirror is disposed on the second surface of the subsidiary substrate of the mother substrate unit.

10. The optical communication interconnect device as claimed in claim 9, wherein mirror is a focusing mirror which includes concave mirror, Fresnel mirror, and Grating mirror; wherein an optical axis of the focusing mirror is coupled to the position reference axis of the subsidiary substrate, the optical axis of the active optical component, and the optical axis of the waveguide member.

11. The optical communication interconnect device as claimed in claim 1, wherein a light absorption body made of light absorption materials is arranged between the two adjacent waveguide members so that light from the adjacent optical channels is absorbed by the light absorption body.

12. The optical communication interconnect device as claimed in claim 11, wherein the light absorption body arranged between the two adjacent waveguide members and facing one end of the active optical component array unit is made of thermally conductive materials which include diamond, aluminum nitride, silicon carbide, and graphite for transferring heat from the active optical component.

13. The optical communication interconnect device as claimed in claim 1, wherein a light absorption body arranged between the two adjacent waveguide members in the waveguide array unit and facing one end of the active optical component array unit is a thermal electric (TE) cooler used for controlling temperature of the active optical component.

14. The optical communication interconnect device as claimed in claim 1, wherein a light absorption body made of light absorption materials is arranged between the two adjacent active optical components so that light from the adjacent optical channels is absorbed by the light absorption body.

15. The optical communication interconnect device as claimed in claim 1, wherein a light absorption body made of light absorption materials is arranged between the two adjacent subsidiary substrates so that light from the adjacent optical channels is absorbed by the light absorption body.

16. The optical communication interconnect device as claimed in claim 1, wherein the optical communication interconnect device includes the at least one optical channel and the optical channels are spaced apart and arranged at the YZ plane in the 3D (XYZ) space to form a 2-dimensional array when the active optical component is a surface emitting light source or an optical detector.

17. The optical communication interconnect device as claimed in claim 1, wherein the optical communication interconnect device includes the at least one optical channel and the optical channels are spaced apart and arranged at the YZ plane in the 3D (XYZ) space to form a 1-dimensional array when the active optical component is an edge emitting light source.

18. The optical communication interconnect device as claimed in claim 1, wherein a width of a YZ section of a photoelectric conversion material of the active optical component is smaller than a width of a YZ section of a core of the waveguide member so that most of light emitted from the photoelectric conversion material of the active optical component is able to enter into the core of the waveguide member.

19. The optical communication interconnect device as claimed in claim 1, wherein the waveguide member of the waveguide array unit includes optical fiber, a waveguide, and a gradient index waveguide (Grin lens).

20. The optical communication interconnect device as claimed in claim 1, wherein the waveguide array unit is extending outward from an area with the waveguide members in Y, Z directions to form a first extension plane which is further used as the first YZ plane; wherein the surface on the area with the waveguide members in the waveguide array unit is away from the active optical component a certain distance compared with the first extension plane.

21. The optical communication interconnect device as claimed in claim 1, wherein the waveguide array unit is extending outward from an area with the waveguide members in Y, Z directions to form a first extension plane which is further used as the first YZ plane; wherein the surface on the area with the waveguide members in the waveguide array unit is away from the active optical components a certain distance compared with the first extension plane.

22. The optical communication interconnect device as claimed in claim 1, wherein the first YZ plane defined on the waveguide array unit is extending outward from an area with the waveguide member in Y, Z directions to form a first extension plane; wherein the second YZ plane defined on the active optical component array unit is extending outward from an area with the active optical component in Y, Z directions to form a second extension plane.

23. The optical communication interconnect device as claimed in claim 22, wherein the first extension plane is provided with at least one alignment key and at least one alignment key is disposed on the second extension plane; wherein when the alignment keys on the second extension plane are aligned with the alignment keys on the first extension plane in (Y, Z) coordinates, the optical axis of the waveguide member in the waveguide array unit and the optical axis of the active optical component in the active optical component array unit are aligned with each other.

24. The optical communication interconnect device as claimed in claim 23, wherein the alignment keys on the first extension plane and the second extension plane are made of magnetic materials; the magnetic alignment keys on the first extension plane and the corresponding magnetic alignment keys on the second extension plane have opposite magnetic poles which attract each other.

25. A manufacturing method of an optical communication interconnect device comprising the steps of:
Step S1: producing a waveguide array unit which includes at least one waveguide member; the waveguide members spaced apart and arranged at the YZ plane in a 3D (XYZ) space to form an array; wherein an optical axis of the waveguide member is parallel to the X-axis in the 3D (XYZ) space; a first YZ plane is defined by a plane on a surface of one side of the waveguide array unit facing an active optical component array unit, closest to the active optical component array unit, and perpendicular to the X-axis;
Step S2: producing an active optical component array unit which includes at least one active optical component; the active optical components are spaced apart and arranged at the YZ plane in the 3D (XYZ) space to form an array; wherein an optical axis of the active optical component is parallel to the X-axis; a second YZ plane is defined by a plane on a surface at one side of the active optical component facing the waveguide array unit, closest to the waveguide array unit, and perpendicular to the X-axis;
Step S3: producing a mother substrate unit which includes at least one subsidiary substrate; the subsidiary substrates spaced apart and arranged at the YZ plane in the 3D (XYZ) space to form an array; wherein the subsidiary substrate is provided with a position reference axis parallel to the X-axis; wherein the subsidiary substrate is provided with a first surface and a second surface along the X-axis; wherein the first surface of the subsidiary substrate is facing the active optical component array unit while the second surface is located opposite to the first surface along the X-axis;
S4: performing alignment and positioning of the waveguide array unit, the active optical component array unit, and the mother substrate unit, and connecting and fixing the waveguide array unit, the active optical component array unit, and the mother substrate unit into one part along the X-axis in the 3D (XYZ) space; wherein the first YZ plane is parallel and attached closely to the second YZ plane and gaps between the first YZ plane and the second YZ plane are filled completely by a filler; an optical index of the filler is larger than an optical index of air; thereby there is no air gap or vacuum gap between the waveguide array unit and the active optical component array unit; wherein the optical axis of each of the waveguide members of the waveguide array unit is coupled to the optical axis of each of the active optical components of the active optical component array unit and the position reference axis of the subsidiary substrate of the mother substrate unit in a one-on-one manner so that the waveguide members, the active optical components, and the subsidiary substrates are connected in turn along the X-axis to form an optical channel; and
Step S5: finishing assembly of the optical communication interconnect device which includes the at least one optical channel and the optical channels are spaced apart and arranged at the YZ plane of the 3D (XYZ) space to form an array.

26. The method as claimed in claim 25, wherein the step S2 further includes the steps of:
Step S2-1: providing an epitaxial substrate; and
Step S2-2: producing an active optical component array unit on the epitaxial substrate by using a semiconductor fabrication process; wherein the active optical component array unit includes at least one active optical component; the active optical components are spaced apart and arranged at the YZ plane in the 3D (XYZ) space to form an array; wherein an optical axis of the respective active optical components is parallel to the X-axis;

27. The method as claimed in claim 25, wherein the step S3 further includes the steps of:
Step S3-1: providing a mother substrate body made of no light absorption materials having a certain thickness in the X-axis in a 3D (XYZ) space; two sides of the thickness are provided with a first surface extending on the YZ plane and a second surface arranged opposite to the first surface and extending on the YZ plane;
S3-2: producing at least one convex surface on the second surface and arranging the convex surfaces apart from one another on the YZ plane in the 3D (XYZ) space to form an array; wherein an optical axis of the respective convex surfaces is parallel to the X-axis;
Step S3-3: forming focusing mirrors by using the concave surface and arranging the focusing mirrors apart from one another on the YZ plane in the 3D (XYZ) space to form an array;
Step S3-4: performing processing to form a first groove with a certain depth between the two adjacent focusing mirrors;
Step S3-5: using light absorption materials to coat and fill the first grooves completely and form a first light absorbing body so that the focusing mirrors are spaced apart by the first light absorbing bodies to form an array on the YZ plane in the 3D (XYZ) space;
Step S3-6: performing processing to form a second groove with a certain depth on the first surface of the mother substrate body and at positions corresponding to the first light absorbing bodies in one-on-one manner; yet a segment of a communication body of the mother substrate body is kept between the second grooves and the first grooves corresponding to each other in one-on-one manner;
Step S3-7: using light absorption materials to coat and fill the second grooves completely and form a second light absorbing body; at least one subsidiary surface is left and formed on the first surface of the mother substrate body; a part of the mother substrate body between the subsidiary surface and the focusing mirrors corresponding to each other in one-on-one manner is defined as a subsidiary substrate; thereby the subsidiary substrates are spaced apart by the first light absorbing bodies and the second light absorbing bodies to form an array on the YZ plane in the 3D (XYZ) space.

28. The method as claimed in claim 27, wherein after the step S3-7 when the active optical component of the active optical component array unit is light emitting diode (LED), vertical cavity surface emitting laser (VCSEL), or optical detector, the method further includes the steps of:
Step S3-8: arranging a first electric contact and solder surface at the subsidiary surface left and formed on the first surface of the mother substrate body; and
Step S3-9: producing a third groove with a certain depth on the subsidiary surface except the subsidiary surface with the electric contact and solder surface of the active optical component and forming a low-level surface by the third grooves; arranging a second electric contact and solder surface on the low-level surface.

29. The method as claimed in claim 25, wherein the step S4 further includes the steps of:
Step S4-1: aligning and positioning the active optical component array unit and the mother substrate unit along the X-axis in the 3D (XYZ space) and connecting them into one part; wherein the optical axis of each of the active optical components of the active optical component array unit is coupled to the position reference axis of the subsidiary substrate of the mother substrate unit in a one-on-one manner; gaps between the active optical component in the active optical component array unit and the subsidiary substrates of the mother substrate unit are filled completely by a filler which is also used as an adhesive; an optical index of the filler is larger than an optical index of air and the filler doesn't absorb optical signals of the optical channels;
Step S4-2: after curing of the filler, the active optical component array unit and the mother substrate unit are adhered and connected by the filler to form a combination body; there is s no air gap or vacuum gap between the active optical component array unit and the mother substrate unit;
Step S4-3: aligning and positioning the waveguide array unit and the combination body of the active optical component array unit with the mother substrate unit along the X-axis in the 3D (XYZ) space and connecting them into one part; wherein the optical axis of each of the waveguide member in the waveguide array unit is coupled to the optical axis of each of the active optical component in the active optical component array unit in one-on-one manner; wherein the first YZ plane is parallel and attached closely to the second YZ plane and gaps between the first YZ plane and the second YZ plane are filled completely by a filler; an optical index of the filler is larger than an optical index of air and the filler doesn't absorb optical signals of the optical channels; thereby there is no air gap or vacuum gap between the waveguide array unit and the active optical component array unit; and
Step S4-4: finishing assembly of the optical communication interconnect device after the waveguide array unit and the combination body of the active optical component array unit with the mother substrate unit being connected into one part and fixed.

30. The method as claimed in claim 25, wherein the step S4 further includes the steps of:
Step S4-5: using an optical axis alignment mechanism for alignment and positioning of the optical axis of the waveguide member in the waveguide array unit and the optical axis of the active optical component while the optical axis of the waveguide member and the optical axis of the active optical component are coupled in one-on-one manner;
Step S4-6: detecting positions of a normal line of the first YZ plane and a normal line of the second YZ plane skew to each other during alignment and positioning of the waveguide array unit and the active optical component array unit; and
Step S4-7: giving information of the positions of the normal line of the first YZ plane and the normal line of the second YZ plane skew to each other to the optical axis alignment mechanism as feedback to make the first YZ plane and the second YZ plane become more parallel to each other; thereby the first YZ plane and the second YZ plane are getting closer to each other.
